(19) United States
(12) Patent Application Publication
(10) Pub. No.: US 2025/0167943 A1
(43) Pub. Date: May 22, 2025

(54) CONFIGURABLE CHANNEL TYPES FOR UNIFIED TRANSMISSION CONFIGURATION INDICATION

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Tao LUO, San Diego, CA (US); Xiaoxia ZHANG, San Diego, CA (US)

(21) Appl. No.: 18/839,706

(22) PCT Filed: Apr. 28, 2022
(86) PCT No.: PCT/CN2022/089812

§ 371 Date: Aug. 19, 2024

(51) Int. Cl. H04L 5/00

(52) U.S. Cl. CPC H04L 5/0035; H04L 5/0053

(57) ABSTRACT

Methods, systems, and devices for wireless communications are described. In some examples, a user equipment (UE) may receive signaling indicating a configuration for the UE to communicate with a first transmission reception point (TRP) and a second TRP. The UE may receive a control signal identifying a set of channels sharing a common transmission configuration indication (TCI), where the common TCI may indicate a first TCI state for the first TRP and a second TCI state for the second TRP. The UE may communicate with at least one of the first TRP or the second TRP according to the common TCI based on receiving the control signal.

### CROSS REFERENCE

The present Application is a 371 national stage filing of International PCT Application No. PCT/CN2022/089812 by YUAN et al. entitled “CONFIGURABLE CHANNEL TYPES FOR UNIFIED TRANSMISSION CONFIGURATION INDICATION,” filed Apr. 28, 2022, which is assigned to the assignee hereof, and which is expressly incorporated by reference in its entirety herein.

### FIELD OF TECHNOLOGY

The following relates to wireless communications, including configurable channel types for unified transmission configuration indication (TCI).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some examples, the communication devices may communicate with multiple transmission reception points (TRPs) simultaneously by using a unified TCI.

### SUMMARY

The described techniques relate to improved methods, systems, devices, and apparatuses that support configurable channel types for unified TCI. Generally, the described techniques provide for a UE to receive signaling indicating a unified TCI to be applied to channels associated with hybrid transmission and reception schemes for wireless communications between the UE and multiple TRPs. For example, the UE may receive signaling indicating a configuration for the UE to communicate with a first TRP and a second TRP. The UE may receive a control signal that identifies a set of channels sharing a common TCI, in which the common TCI indicates a first TCI state for the first TRP and a second TCI state for the second TRP. The UE may communicate with at least one of the first TRP or the second TRP in accordance with the common TCI based on receiving the control signal.

A method for wireless communication at a user equipment (UE) is described. The method may include receiving signaling indicating a configuration for the UE to communicate with a first transmission reception point and a second transmission reception point, receiving a control signal identifying a set of channels sharing a common transmission configuration indication, the common transmission configuration indication including a first transmission configuration indicator state for the first transmission reception point and a second transmission configuration indicator state for the second transmission reception point, and communicating with at least one of the first transmission reception point or the second transmission reception point according to the common transmission configuration indication based on the received control signal.

An apparatus for wireless communication at a UE is described. The apparatus may include a processor, memory coupled with the processor, and instructions stored in the memory. The instructions may be executable by the processor to cause the apparatus to receive signaling indicating a configuration for the UE to communicate with a first transmission reception point and a second transmission reception point, receive a control signal identifying a set of channels sharing a common transmission configuration indication, the common transmission configuration indication including a first transmission configuration indicator state for the first transmission reception point and a second transmission configuration indicator state for the second transmission reception point, and communicate with at least one of the first transmission reception point or the second transmission reception point according to the common transmission configuration indication based on the received control signal.

Another apparatus for wireless communication at a UE is described. The apparatus may include means for receiving signaling indicating a configuration for the UE to communicate with a first transmission reception point and a second transmission reception point, means for receiving a control signal identifying a set of channels sharing a common transmission configuration indication, the common transmission configuration indication including a first transmission configuration indicator state for the first transmission reception point and a second transmission configuration indicator state for the second transmission reception point, and means for communicating with at least one of the first transmission reception point or the second transmission reception point according to the common transmission configuration indication based on the received control signal.

A non-transitory computer-readable medium storing code for wireless communication at a UE is described. The code may include instructions executable by a processor to receive signaling indicating a configuration for the UE to communicate with a first transmission reception point and a second transmission reception point, receive a control signal identifying a set of channels sharing a common transmission configuration indication, the common transmission configuration indication including a first transmission configuration indicator state for the first transmission reception point and a second transmission configuration indicator state for the second transmission reception point, and communicate with at least one of the first transmission reception point or the second transmission reception point according to the common transmission configuration indication based on the received control signal.

In some examples of the method, apparatuses, and non-transitory computer-readable medium described herein, receiving the control signal may include operations, features, means, or instructions for receiving the control signal identifying at least one channel associated with a second transmission configuration indication indicating one or more transmission configuration indicator states for the first transmission reception point, the second transmission reception point, or both, where the second transmission configuration indication may be different from the common transmission configuration indication.

In some examples of the method, apparatuses, and non-transitory computer-readable medium described herein, receiving the control signal may include operations, features, means, or instructions for receiving the control signal identifying at least one reference signal type associated with a second transmission configuration indication indicating one or more transmission configuration indicator states for the first transmission reception point, the second transmission reception point, or both, where the second transmission configuration indication may be different from the common transmission configuration indication.

In some examples of the method, apparatuses, and non-transitory computer-readable medium described herein, receiving the control signal may include operations, features, means, or instructions for receiving the control signal indicating that the set of channels associated with a common reference signal type shares the common transmission configuration indication.

Some examples of the method, apparatuses, and non-transitory computer-readable medium described herein may further include operations, features, means, or instructions for receiving a downlink control information including a first transmission configuration indication field and a second transmission configuration indication field, where the first transmission configuration indication field indicates the first transmission configuration indication state, and the second transmission configuration indication field indicates the second transmission configuration indication state.

In some examples of the method, apparatuses, and non-transitory computer-readable medium described herein, the first transmission configuration indicator state, the second transmission configuration indicator state, or both include at least one of a respective joint transmission configuration indicator state, a downlink transmission configuration indicator state, an uplink transmission configuration indicator state, or any combination thereof.

In some examples of the method, apparatuses, and non-transitory computer-readable medium described herein, the set of channels includes at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

In some examples of the method, apparatuses, and non-transitory computer-readable medium described herein, the control signal includes a radio resource control signaling or medium access control (MAC) control element (MAC-CE) signaling indicating the set of channels.

A method for wireless communication at a UE is described. The method may include receiving signaling indicating a configuration for the UE to communicate with a first transmission reception point and a second transmission reception point, receiving a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and communicating with at least one of the first transmission reception point or the second transmission reception point according to the common transmission configuration indication based on the received control signal.

An apparatus for wireless communication at a UE is described. The apparatus may include a processor, memory coupled with the processor, and instructions stored in the memory. The instructions may be executable by the processor to cause the apparatus to receive signaling indicating a configuration for the UE to communicate with a first transmission reception point and a second transmission reception point, receive a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and communicate with at least one of the first transmission reception point or the second transmission reception point according to the common transmission configuration indication based on the received control signal.

Another apparatus for wireless communication at a UE is described. The apparatus may include means for receiving signaling indicating a configuration for the UE to communicate with a first transmission reception point and a second transmission reception point, means for receiving a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and means for communicating with at least one of the first transmission reception point or the second transmission reception point according to the common transmission configuration indication based on the received control signal.

A non-transitory computer-readable medium storing code for wireless communication at a UE is described. The code may include instructions executable by a processor to receive signaling indicating a configuration for the UE to communicate with a first transmission reception point and a second transmission reception point, receive a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and communicate with at least one of the first transmission reception point or the second transmission reception point according to the common transmission configuration indication based on the received control signal.

In some examples of the method, apparatuses, and non-transitory computer-readable medium described herein, receiving the control signal may include operations, features, means, or instructions for receiving the control signal identifying the mapping between the one or more channels and a transmission configuration indication field included in the common transmission configuration indication.

In some examples of the method, apparatuses, and non-transitory computer-readable medium described herein, receiving the control signal may include operations, features, means, or instructions for receiving the control signal identifying the mapping between a first transmission configuration indication codepoint and one or more transmission configuration indications associated with a physical downlink control channel and the mapping between a second transmission configuration indication codepoint and one or more transmission configuration indications associated with a physical downlink shared channel.

In some examples of the method, apparatuses, and non-transitory computer-readable medium described herein, receiving the control signal may include operations, features, means, or instructions for receiving the control signal identifying a transmission configuration indication codepoint of a single unified transmission configuration indication, where the single unified transmission configuration indication indicates one or more transmission configuration indication states for one or more channels configured without repetition.

In some examples of the method, apparatuses, and non-transitory computer-readable medium described herein, receiving the control signal may include operations, features, means, or instructions for receiving the control signal identifying a transmission configuration indication codepoint of a set of multiple unified transmission configuration indications, where the set of multiple unified transmission configuration indication indicates one or more transmission configuration indication states for one or more channels configured with repetition.

Some examples of the method, apparatuses, and non-transitory computer-readable medium described herein may further include operations, features, means, or instructions for receiving a downlink control information message including a first transmission configuration indication field and a second transmission configuration indication field, the first transmission configuration indication field indicating one or more transmission configuration indication states for a physical downlink control channel, and the second transmission configuration indication field indicating one or more transmission configuration indication states for a physical downlink shared channel.

Some examples of the method, apparatuses, and non-transitory computer-readable medium described herein may further include operations, features, means, or instructions for receiving a first medium access control (MAC) control element (MAC-CE) activating the first transmission configuration indicator state for the first transmission reception point, where communicating with the first transmission reception point may be based on receiving the first media access control (MAC)-CE and receiving a second MAC-CE activating the second transmission configuration indicator state for the second transmission reception point, where communicating with the second transmission reception point may be based on receiving the second MAC-CE.

In some examples of the method, apparatuses, and non-transitory computer-readable medium described herein, the first transmission configuration indicator state, the second transmission configuration indicator state, or both include at least one of a respective joint transmission configuration indicator state, a downlink transmission configuration indicator state, an uplink transmission configuration indicator state, or any combination thereof.

In some examples of the method, apparatuses, and non-transitory computer-readable medium described herein, the control signal includes a radio resource control signaling or medium access control (MAC) control element (MAC-CE) signaling indicating the one or more channels.

A method for wireless communication at a network entity is described. The method may include outputting signaling indicating a configuration for a UE to communicate with a first transmission reception point and a second transmission reception point, outputting a control signal identifying a set of channels sharing a common transmission configuration indication, the common transmission configuration indication indicating a first transmission configuration indicator state for the first transmission reception point and a second transmission configuration indicator state for the second transmission reception point, and communicating with the UE according to the common transmission configuration indication based on outputting the control signal.

An apparatus for wireless communication at a network entity is described. The apparatus may include a processor, memory coupled with the processor, and instructions stored in the memory. The instructions may be executable by the processor to cause the apparatus to output signaling indicating a configuration for a UE to communicate with a first transmission reception point and a second transmission reception point, output a control signal identifying a set of channels sharing a common transmission configuration indication, the common transmission configuration indication indicating a first transmission configuration indicator state for the first transmission reception point and a second transmission configuration indicator state for the second transmission reception point, and communicate with the UE according to the common transmission configuration indication based on outputting the control signal.

Another apparatus for wireless communication at a network entity is described. The apparatus may include means for outputting signaling indicating a configuration for a UE to communicate with a first transmission reception point and a second transmission reception point, means for outputting a control signal identifying a set of channels sharing a common transmission configuration indication, the common transmission configuration indication indicating a first transmission configuration indicator state for the first transmission reception point and a second transmission configuration indicator state for the second transmission reception point, and means for communicating with the UE according to the common transmission configuration indication based on outputting the control signal.

A non-transitory computer-readable medium storing code for wireless communication at a network entity is described. The code may include instructions executable by a processor to output signaling indicating a configuration for a UE to communicate with a first transmission reception point and a second transmission reception point, output a control signal identifying a set of channels sharing a common transmission configuration indication, the common transmission configuration indication indicating a first transmission configuration indicator state for the first transmission reception point and a second transmission configuration indicator state for the second transmission reception point, and communicate with the UE according to the common transmission configuration indication based on outputting the control signal.

In some examples of the method, apparatuses, and non-transitory computer-readable medium described herein, outputting the control signal may include operations, features, means, or instructions for outputting the control signal identifying at least one channel associated with a second transmission configuration indication indicating one or more transmission configuration indicator states for the first transmission reception point, the second transmission reception point, or both, where the second transmission configuration indication may be different from the common transmission configuration indication.

In some examples of the method, apparatuses, and non-transitory computer-readable medium described herein, outputting the control signal may include operations, features, means, or instructions for outputting the control signal identifying at least one reference signal type associated with a second transmission configuration indication indicating one or more transmission configuration indicator states for the first transmission reception point, the second transmission reception point, or both, where the second transmission configuration indication may be different from the common transmission configuration indication.

In some examples of the method, apparatuses, and non-transitory computer-readable medium described herein, outputting the control signal may include operations, features, means, or instructions for outputting the control signal indicating that the set of channels associated with a common reference signal type shares the common transmission configuration indication.

Some examples of the method, apparatuses, and non-transitory computer-readable medium described herein may further include operations, features, means, or instructions for outputting a downlink control information including a first transmission configuration indication field and a second transmission configuration indication field, where the first transmission configuration indication field indicates the first transmission configuration indication state, and the second transmission configuration indication field indicates the second transmission configuration indication state.

In some examples of the method, apparatuses, and non-transitory computer-readable medium described herein, the first transmission configuration indicator state, the second transmission configuration indicator state, or both include at least one of a respective joint transmission configuration indicator state, a downlink transmission configuration indicator state, an uplink transmission configuration indicator state, or any combination thereof.

In some examples of the method, apparatuses, and non-transitory computer-readable medium described herein, the set of channels includes at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

In some examples of the method, apparatuses, and non-transitory computer-readable medium described herein, the control signal includes a radio resource control signaling or medium access control (MAC) control element (MAC-CE) signaling indicating the set of channels.

A method for wireless communication at a network entity is described. The method may include outputting signaling indicating a configuration for a UE to communicate with a first transmission reception point and a second transmission reception point, outputting a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and communicating with the UE according to the common transmission configuration indication based on receiving the control signal.

An apparatus for wireless communication at a network entity is described. The apparatus may include a processor, memory coupled with the processor, and instructions stored in the memory. The instructions may be executable by the processor to cause the apparatus to output signaling indicating a configuration for a UE to communicate with a first transmission reception point and a second transmission reception point, output a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and communicate with the UE according to the common transmission configuration indication based on receiving the control signal.

Another apparatus for wireless communication at a network entity is described. The apparatus may include means for outputting signaling indicating a configuration for a UE to communicate with a first transmission reception point and a second transmission reception point, means for outputting a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and means for communicating with the UE according to the common transmission configuration indication based on receiving the control signal.

A non-transitory computer-readable medium storing code for wireless communication at a network entity is described. The code may include instructions executable by a processor to output signaling indicating a configuration for a UE to communicate with a first transmission reception point and a second transmission reception point, output a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point, and communicate with the UE according to the common transmission configuration indication based on receiving the control signal.

In some examples of the method, apparatuses, and non-transitory computer-readable medium described herein, outputting the control signal may include operations, features, means, or instructions for outputting the control signal identifying the mapping between the one or more channels and a transmission configuration indication field included in the common transmission configuration indication.

In some examples of the method, apparatuses, and non-transitory computer-readable medium described herein, outputting the control signal may include operations, features, means, or instructions for outputting the control signal identifying the mapping between a first transmission configuration indication codepoint and one or more transmission configuration indications associated with a physical downlink control channel and the mapping between a second transmission configuration indication codepoint and one or more transmission configuration indications associated with a physical downlink shared channel.

In some examples of the method, apparatuses, and non-transitory computer-readable medium described herein, outputting the control signal may include operations, features, means, or instructions for outputting the control signal identifying a transmission configuration indication codepoint of a single unified transmission configuration indication, where the single unified transmission configuration indication indicates one or more transmission configuration indication states for one or more channels configured without repetition.

In some examples of the method, apparatuses, and non-transitory computer-readable medium described herein, outputting the control signal may include operations, features, means, or instructions for outputting the control signal identifying a transmission configuration indication codepoint of a set of multiple unified transmission configuration indications, where the set of multiple unified transmission configuration indication indicates one or more transmission configuration indication states for one or more channels configured with repetition.

### BRIEF DESCRIPTION OF THE DRAWINGS

FIG. 1 illustrates an example of a wireless communications system that supports configurable channel types for unified TCI in accordance with one or more aspects of the present disclosure.

FIG. 2 illustrates an example of a unified TCI indication that supports configurable channel types for unified TCI in accordance with one or more aspects of the present disclosure.

FIG. 3 illustrates an example of a unified TCI indication that supports configurable channel types for unified TCI in accordance with one or more aspects of the present disclosure.

FIG. 4 illustrates examples of unified TCI indication schemes that support configurable channel types for unified TCI in accordance with one or more aspects of the present disclosure.

FIG. 5 illustrates an example of a process flow that supports configurable channel types for unified TCI in accordance with one or more aspects of the present disclosure.

FIGS. 6 and 7 show diagrams of devices that support configurable channel types for unified TCI in accordance with one or more aspects of the present disclosure.

FIG. 8 shows a diagram of a communications manager that supports configurable channel types for unified TCI in accordance with one or more aspects of the present disclosure.

FIG. 9 shows a diagram of a system including a device that supports configurable channel types for unified TCI in accordance with one or more aspects of the present disclosure.

FIGS. 10 and 11 show diagrams of devices that support configurable channel types for unified TCI in accordance with one or more aspects of the present disclosure.

FIG. 12 shows a diagram of a communications manager that supports configurable channel types for unified TCI in accordance with one or more aspects of the present disclosure.

FIG. 13 shows a diagram of a system including a device that supports configurable channel types for unified TCI in accordance with one or more aspects of the present disclosure.

FIGS. 14 through 18 show flowcharts illustrating methods that support configurable channel types for unified TCI in accordance with one or more aspects of the present disclosure.

### DETAILED DESCRIPTION

Wireless communications systems may support communications between a UE and multiple TRPs. In some examples, the UE may communicate with multiple TRPs in a multi-TRP (mTRP) mode. For instance, the UE may perform simultaneous communications with a first TRP and a second TRP. In some examples, communicating with a TRP may include the UE receiving downlink control information (DCI) that indicates a TCI state for communication between the TRP and the UE. When the UE communicates in the mTRP mode, the first TRP or the second TRP may indicate a unified TCI indication in the DCI. The unified TCI indication may indicate a first TCI state for the first TRP and a second TCI state for the second TRP. The UE may use the unified TCI indication for communications with the TRPs on multiple channels. Such channels may be referred to as mTRP channels. In some cases, the mTRP channels may be associated with hybrid transmission and reception schemes. In some examples, the UE may be unable to map the TCI states in the unified TCI indication to the mTRP channels associated with different transmission and reception schemes. For instance, the UE may not be aware of the TCI states which correspond to the respective mTRP channels. In such cases, the UE may be unable to apply the unified TCI when communicating with multiple TRPs using the different mTRP channels.

One or more aspects of the present disclosure describe techniques to convey multiple TCI states for mTRP channels associated with different transmission and reception schemes. In some examples, the UE may receive a control signal identifying a set of channels that share a common TCI indication. For cases in which a target channel does not share the common TCI indication, the network entity may use a separate TCI indication to indicate the TCI state associated with the target channel. In some examples, the UE may receive a control signal identifying a mapping between one or more channels and one or more TCI codepoints (e.g., a first TCI codepoint that maps to physical downlink control channels (PDCCHs) and a second TCI codepoint that maps to physical downlink shared channels (PDSCHs). Accordingly, the UE may determine an associated TCI state for each TRP even when different transmission and reception channels are used, thus increasing the efficiency of wireless communications.

Aspects of the disclosure are initially described in the context of wireless communications systems. Additional aspects of the disclosure are described in the context of a unified TCI indication, unified TCI indication schemes, and a process flow. Aspects of the disclosure are further illustrated by and described with reference to apparatus diagrams, system diagrams, and flowcharts that relate to configurable channel types for unified TCI.

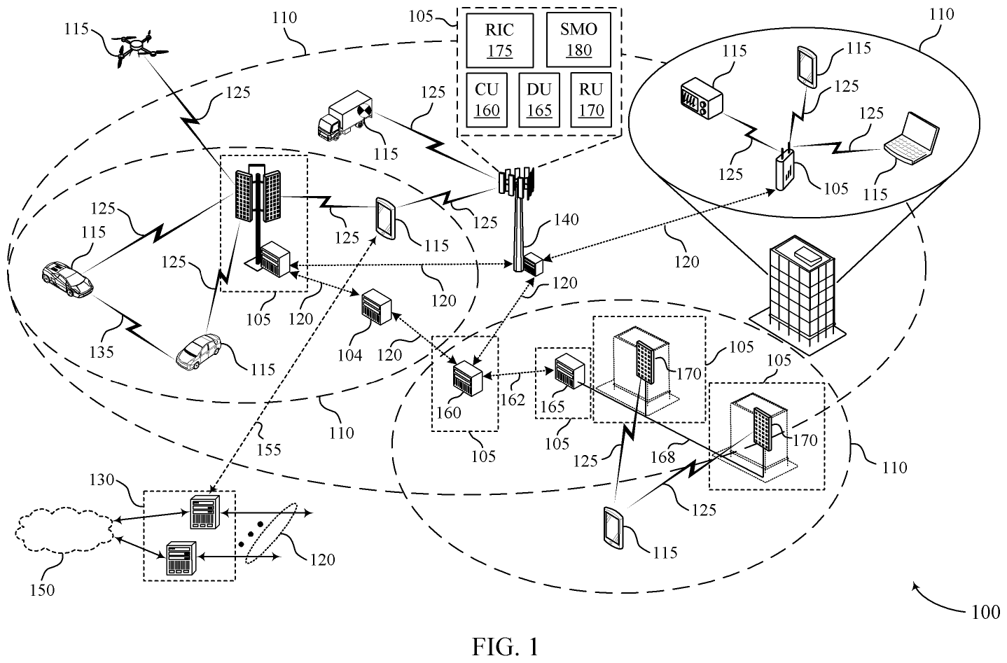

FIG. 1 illustrates an example of a wireless communications system 100 that supports configurable channel types for unified TCI in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support configurable channel types for unified TCI as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

Wireless communications systems may support the use of various types of unified TCIs. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g., a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information (SRI) to indicate a beam for a single uplink channel or reference signal.

In some examples, a TCI state may include at least one source reference signal to provide a reference for determining quasi-co location (QCL) information for downlink reception or spatial filter information for uplink transmission. For a separate downlink TCI, the source reference signal(s) in M TCIs may provide QCL information at least for UE-dedicated reception on a PDSCH and for UE-dedicated reception on each or a subset of control resource sets (CORESETs) in a component carrier (CC). For a separate uplink TCI, the source reference signal(s) in N TCIs may provide a reference for determining one or more common uplink transmit spatial filters at least for a dynamic-grant or configured-grant based physical uplink shared channel (PUSCH) on all or a subset of dedicated physical uplink control channel (PUCCH) resources in a CC. In some examples, the uplink transmit spatial filter may apply to each sounding reference signal (SRS) resource in resource sets configured for antenna switching, codebook-based uplink transmissions, non-codebook based uplink transmissions, or any combination thereof.

For separate downlink and uplink TCI, the UE and the network entity may use one instance of beam indication using DCI format 1_1 (e.g., with a downlink assignment) or DCI format 1_2 (e.g., without a downlink assignment) such that one TCI field codepoint represents a pair of downlink TCI and uplink TCI states, one TCI field codepoint represents one downlink TCI state, one TCI field codepoint represents one uplink TCI state, or any combination thereof.

A UE 115 may communicate with a TRP (e.g., a network entity 105). In some examples, the UE 115 may communicate with multiple TRPs in an mTRP mode. For instance, the UE 115 may perform simultaneous communications with a first TRP and a second TRP. When communicating in an mTRP mode, transmitting multiple DCIs to convey multiple TCI states for different channels and/or reference signals may increase a latency associated with communications between the UE 115 and at least one of the TRPs. Accordingly, communicating in a mTRP mode may include the UE 115 receiving a single DCI that indicates TCI states for multiple TRPs. In a first example, a single DCI may include multiple TCI-indication fields, where each field may indicate a respective TCI state for a respective TRP (e.g., a first TCI indication field for a first TRP and a second TCI indication field for a second TRP). In a second example, the DCI may be configured with one TCI field whose codepoint maps to multiple TCI states (e.g., a single TCI field that maps to a first TCI state for a first TRP and a second TCI state for a second TRP). In a third example, a single DCI may be configured with one TCI field that points to one TCI.

In some examples, the UE 115 communicating in mTRP mode, may communicate with multiple TRPs by using multiple TRP channels. That is, the multiple TRP channels may facilitate simultaneous communications between the UE 115 and multiple TRPs. In some cases, the multiple TRP channels may be configured or scheduled with hybrid transmission reception schemes. For instance, a UE 115 in mTRP mode may receive a single DCI that may apply a unified TCI indication to multiple TRP channels.

In some cases, the UE 115 may communicate with the multiple TRPs by using multiple TRP channels associated with hybrid transmission reception schemes. The multiple TRP channels may include downlink channels (e.g., PDCCHs, PDSCHs), uplink channels (e.g., PUCCHs), PUSCHs), and reference signals (e.g., for beam management or channel state information (CSI) acquisition). In some examples, one or multiple TRP channels may be dedicated or non-dedicated to the UE 115. Additionally or alternatively, the one or multiple TRP channels may be dynamically granted or configurably granted. In some examples, the multiple TRP channels may be configured or scheduled for repetitions using multiple TRPs or without repetitions using a single TRP. Accordingly, the multiple TRP channels may be associated with hybrid transmission reception schemes that involve any combination of the aforementioned characteristics (e.g., a PDCCH configured with repetition and a PDSCH scheduled without repetition, a UE-dedicated PDCCH and a UE-dedicated PDSCH, etc.).

Because the multiple TRP channels may be associated with hybrid transmission reception schemes, the UE 115 may not be aware of which TCI states correspond to the multiple TRP channels. Accordingly, the UE 115 may determine TCI states for TRPs by using a single DCI (that is, by using a unified TCI of M>1 and N>1, where M is the quantity of downlink applicable TCI states and N is the quantity of uplink applicable TCI states) when a single transmission reception scheme is used amongst the multiple TRP channels. For cases in which the multiple TRP channels may have hybrid transmission reception schemes, the UE 115 may determine a TRP state associated with each TRP from a single DCI by receiving higher layer signaling (e.g., radio resource control (RRC) or medium access control (MAC) control element (MAC-CE)) which configures a set of channels to share a common TCI. Accordingly, the UE 115 and the network entity 105 may apply unified TCI may to multiple TRP channels with hybrid transmission reception schemes, thus increasing the efficiency of wireless communications systems.

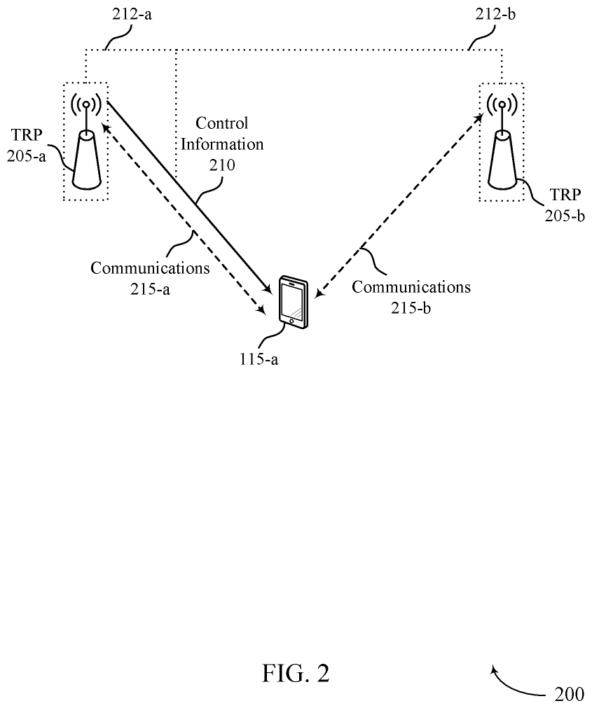

FIG. 2 illustrates an example of a wireless communications system 200 that supports configurable channel types for unified TCI in accordance with one or more aspects of the present disclosure. In some examples, the wireless communications system 200 may be implemented by one or more aspects of the wireless communications system 100. For instance, TRP 205-a and TRP 205-b may each be an example of a network entity 105 as described with reference to FIG. 1. Additionally or alternatively, a UE 115-a may be an example of a UE 115 as described with reference to FIG. 1.

The UE 115-a may operate in an mTRP mode with the TRPs 205-a and 205-b. For instance, the UE 115-a may be capable of performing simultaneous communication with the TRPs 205-a and 205-b. In some examples, the UE 115-a may support various unified TCI types for single TRP (sTRP) operation. In such examples, the UE 115-a may receive a single indication with either a single joint TCI state or separate TCI states for uplink channels or reference signals and downlink channels or reference signals. Additionally, the UE 115-a may support a unified TCI for mTRP operation when the uplink channels or reference signal and downlink channels or reference signals are associated with hybrid transmission reception schemes. The present disclosure may describe techniques that enable the UE 115-a to receive an indication of multiple beams with a single TCI indication, even when the channels or reference signals have hybrid transmission reception schemes.

In some examples, when the UE 115-a is configured for mTRP operation, the UE 115-a may receive an indication of multiple beams for mTRP operation in a single TCI field of DCI. For instance, the UE 115-a may receive signaling (e.g., from one of the TRP 205-a and TRP 205-b) identifying a configuration for the UE 115-a to communicate with the TRPs 205-a and 205-b. The UE 115-a may receive a control information 210 (e.g., DCI) that includes one or more TCI fields, the one or more TCI fields indicating a first TCI state 212-a for the TRP 205-a and a second TCI state 212-b for the TRP 205-b. In some examples, the control information 210 may be transmitted via RRC signaling or MAC-CE signaling. The UE 115-a may communicate with at least one of the TRPs 205-a or 205-b according to the one or more TCI fields based on receiving control information 210. For instance, the UE 115-a may perform communications 215-a with the TRP 205-a, communications 215-b with the TRP 205-b, or both.

In some examples, a single instance of the control information 210 (e.g., a single DCI) may be configured with multiple TCI fields. For instance, the control information 210 may include a unified TCI framework containing a first codepoint in a first field of the control information 210 and a second codepoint in a second field of the control information 210. In the unified TCI framework, the first codepoint may indicate the first TCI state 212-a and the second codepoint may indicate the second TCI state 212-b. In such examples, each of the first field and the second field may indicate a respective joint TCI state, a downlink TCI state, an uplink TCI state, or any combination thereof. In some examples, the mapping order between the TCI fields and the TRPs may be predetermined based on a fixed rule or configured by higher layer signaling. For example, the first TCI field may be intended for the first TRP, and the second TCI field may be intended for the second TRP. Additionally or alternatively, one of the first TCI state 212-a or the second TCI state 212-b may be associated with a null TCI state for the TRP 205-a or the TRP 205-b. In such examples, the communicating may include communicating with the other of the TRP 205-a or the TRP 205-b, respectively.

In some aspects, the control information 210 may indicate a set of channels or reference signals that share a unified TCI. In other words, the control information 210 may define target channels or reference signals which may be applicable to a unified TCI. The unified TCI shared amongst the set of channels or reference signals may be referred to as a common TCI.

In some cases, the set of channels may include at least one of the following: a UE-dedicated reception on a PDSCH (UE-dedicated PDSCH), a UE-dedicated reception on a PDCCH (UE-dedicated PDCCH), a non-UE dedicated reception on a PDSCH (non-UE-dedicated PDSCH), a non-UE dedicated reception on a PDCCH (non-UE dedicated PDCCH), an aperiodic CSI-RS, a dynamic grant-based PUSCH (DG PUSCH), a configured grant-based PUSCH (CG PUSCH), a dedicated PUCCH, a sounding reference signal (SRS), or any combination of the aforementioned channels. In some examples, the control information 210 may indicate that the set of channels (e.g., UE-dedicated channels, non-UE dedicated channels, aperiodic reference signals, periodic reference signals, etc.) share a common TCI. For instance, in some examples, the control information 210 may indicate that a UE-dedicated PDSCH and a UE-dedicated PDSCH share the common TCI. In other examples, a non-UE dedicated PDCCH and a non-UE dedicated PDCCH associated with a serving cell may share the common TCI.

In some cases, one or multiple channels may not share the common TCI. In such cases, the control information 210 may identify the one or multiple channels and associate them with a second TCI (e.g., a separate unified TCI or separate TCIs for each channel) that is different from the common TCI. Similar to the common TCI, the second TCI may indicate one or more TCI states for the first TRP, the second TRP, or both. However, the one or multiple channels associated with the second TCI may share different TCI states than what is indicated in the common TCI. In other words, the second TCI may update or configure the one or multiple channels which were not associated with the common TCI. In some aspects, the second TCI may indicate the second TCI state 212-b for the TRP 205-a and the first TCI state 212-a for the second TRP 212-b. In other aspects, the second TCI may indicate a third TCI state for the TRP 205-a and a fourth TCI state for the second TRP 212-b.

In other examples, the network entity may include a single TCI field in the control information 210, where each codepoint for the TCI field is mapped with one or more channels and one or more TCI states, respectively. In some aspects, the control information 210 may include a codepoint in a field of the control information 210, where the codepoint indicates the first TCI state 212-a and the second TCI state 212-b for the one or more channels associated with a common type. For instance, in some examples, the control information 210 may map a first TCI codepoint and one or more TCIs to a PDCCH channel type. In such examples, the control information 210 may also map a second TCI codepoint and one or more TCIs to a PDSCH channel type.

In other aspects, the control information 210 may include a first TCI codepoint in a field of the control information 210 associated with a single unified TCI of M=1 and N=1, where the first TCI codepoint (and hence, the single unified TCI) indicates the first TCI state 212-a and the second TCI state 212-b for the one or more channels configured without repetition. Additionally or alternatively, the control information 210 may include a second TCI codepoint in a field of the control information 210 associated with multiple unified TCIs (for M>1 and N>1), where the second TCI codepoint (and hence, the multiple unified TCIs) indicates the first TCI state 212-a and the second TCI state 212-b for the one or more channels configured with repetition.

In other aspects, a first TCI field in the control information 210 may be configured to indicate one or more TCI states for a first set of channels, and a second TCI field in the control information 210 may be configured to indicate one or more TCI states for a second set of channels. In other words, the control information 210 may identify a mapping between one or more channels (e.g., the first of channels or the second set of channels) and a TCI field. In some examples, the mapping between the one or more channels and a TCI field may be based on a channel type. For instance, the first TCI field of the control information 210 may indicate the first TCI state 212-a for a PDCCH channel type, and the second TCI field of the control information 210 may indicate the second TCI state 212-b for a PDSCH channel type.

In some examples, a mapping order between the TCI codepoints and the channels associated with the TCI states may be predetermined based on a fixed rule or configured by higher layer signaling. In some examples, the TCI field may indicate two joint TCI states, two downlink TCI states, two uplink TCI states, or any combination thereof. For instance, a codepoint of the TCI field may be mapped to two downlink TCI states and two uplink TCI states for the corresponding channels.

In some examples, the UE 115-a may activate TCIs based on receiving the control information 210 indicating multiple TCI codepoints. In one example, the UE 115-a may receive, from the TRP 205-a or the TRP 205-b, a MAC-CE for each TCI to be activated. For instance, the UE 115-a may receive a first MAC-CE transmission indicating to activate the first TCI state 212-a for the TRP 205-a and may also receive a second MAC-CE transmission indicating to activate the second TCI state 212-b for the TRP 205-b. In another example, the UE 115-a may receive, from the TRP 205-a or the TRP 205-b, a single MAC-CE for activating each TCI indicated in the control information 210. For instance, the UE 115-a may receive a single MAC-CE transmission indicating to activate the first TCI state 212-a for the TRP 205-a and the second TCI state 212-b for the TRP 205-b.

In some examples, the techniques described herein may be associated with one or more advantages. For instance, receiving the control signaling 210 which configures a set of channels to correspond to a common TCI may allow for the indication of multiple TCI states in a single instance control information 210 (e.g., a single DCI) via a unified TCI for channels associated with hybrid transmission reception schemes. Thus, configuring the set of channels to share the common TCI may be associated with decreased latency as compared to applying a unified TCI to a variety of channels which have no mapping to the TCI states indicated by the unified TCI. Accordingly, the efficiency of wireless communications may increase.

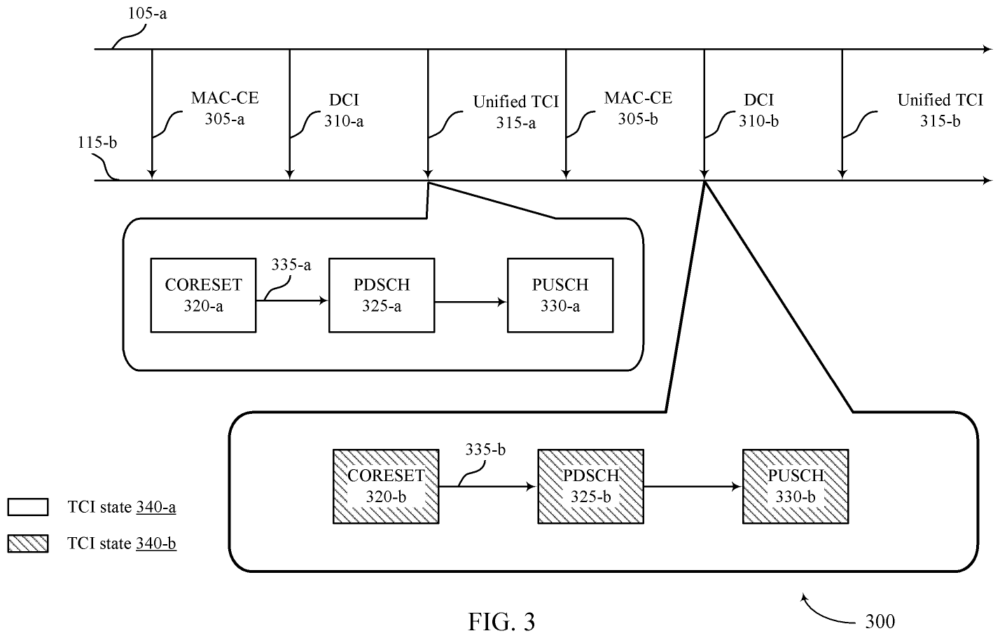

FIG. 3 illustrates an example of a unified TCI indication 300 that supports configurable channel types for unified TCI in accordance with one or more aspects of the present disclosure. In some examples, the unified TCI indication 300 may implement one or more aspects of wireless communications system 100. For instance, a UE 115-b may be an example of a UE 115 as described with reference to FIG. 1. Additionally or alternatively, a network entity 105-a may be an example of a network entity 105 as described with reference to FIG. 1.

In some examples, the UE 115-b in mTRP mode may receive a unified TCI 315 (for M=1 and N=1) per TRP by receiving multiple DCI messages (for examples, a DCI 310-a and a DCI 310-b). The DCI 310-a may be associated with the TRP 205-a, and the DCI 310-b may be associated with the TRP 205-b. In some examples, the UE 115-b may receive, from the network entity 105-a, a MAC-CE or RRC configuration corresponding to each of the TCI states 340 (e.g., a TCI state 340-a and a TCI state 340-b) to indicate activation of the TCI states 340 for the TRP 205-a and the TRP 205-b, respectively. In other examples, as illustrated in FIG. 3, the UE 115-a may receive, from the network entity 105-a, a single MAC-CE 305 for activating each TCI indicated in the control information 210. In such examples, the MAC-CE 305 may utilize different indexing values (e.g., (′ORESETPoolIndex0, CORESETPoolIndex1), where each indexing value may be associated with each of the TCI states 340 to activate the TCI states 340. For example, the UE 115-b may receive the MAC-CE 305-a, which may be associated with the CORESETPoolIndex0, and the MAC-CE 305-b, which may be associated with the CORESETPoolIndex1.

In some examples, the UE 115-b may receive a unified TCI 315-a for communication with the TRP 205-a and a unified TCI 315-b for communication with the TRP 205-b. In some examples, the UE 115-b may map the CORESETPoolIndex0 to a CORESET 320-a, and the UE 115-b may also map the CORESETPoolIndex1 to a CORESET 320-b. By indicating the CORESETPoolIndex0 and the CORESETPoolIndex1, the MAC-CE 305 may indicate resources from the CORESET 320-a (e.g., scheduling resources) to indicate a PDSCH 325-a used for communication between the UE 115-b and the TRP 205-a, and the MAC-CE 305 may also indicate resources from the CORESET 320-b to indicate a PDSCH 325-b used for communicating with the second TRP 205-a.

Accordingly, the UE 115-b may receive the CORESET 320-a of the CORESETPoolIndex0, perform a scheduling 335-a for a PDSCH 325-a which may be received from the TRP 205-a. The scheduling 335-a may allow the UE 115-b to monitor for the PDSCH 325-a. Based on receiving the PDSCH 325-a from the TRP 205-a, the UE 115-b may transmit a PUSCH 330-a to the TRP 205-a to indicate an acknowledgement (ACK) and provide a HARQ feedback to the TRP 205-a. Additionally or alternatively, the UE 115-b may receive the CORESET 320-b of the CORESETPoolIndex1, perform a scheduling 335-b for a PDSCH 325-b which the UE 115-b may receive from the TRP 205-b, and transmit a PUSCH 330-b to the TRP 205-b to indicate the ACK.

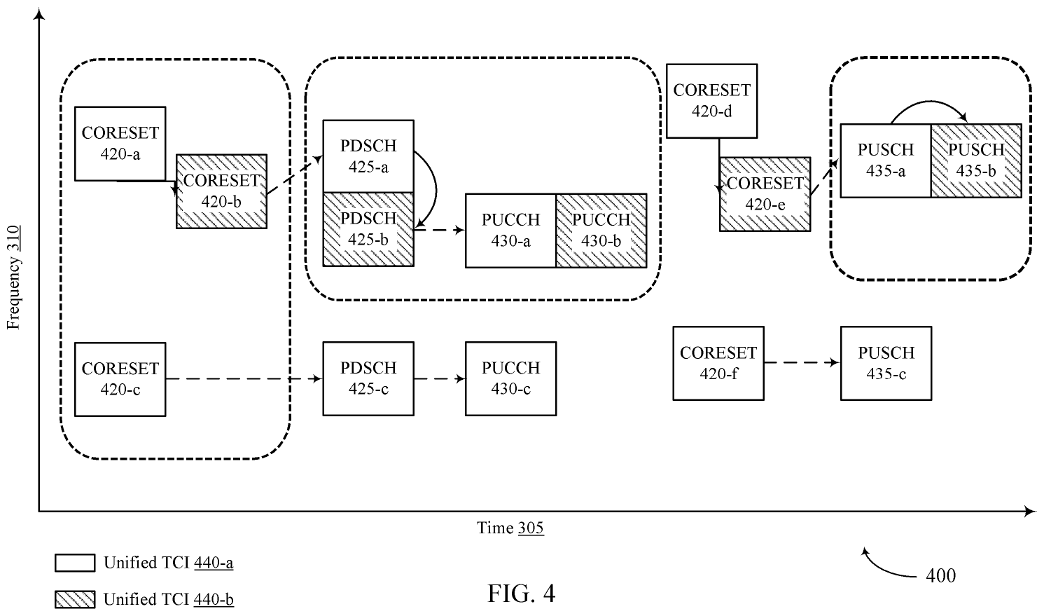

FIG. 4 illustrates examples of unified TCI indication schemes 400 that supports configurable channel types for unified TCI in accordance with one or more aspects of the present disclosure. In some examples, the unified TCI indication schemes may implement one or more aspects of the unified TCI indication 300. For instance, CORESETs 420, PDSCHs 425, and PUSCHs 435 may each be an example of CORESETs 320, PDSCHs 325, and PUSCHs 430 as described with reference to FIG. 3. The unified TCI indication schemes 400 may be understood with respect to a time 405 and a frequency 410.

In some examples, a UE 115 in mTRP mode may receive a common unified TCI (or a common TCI), indicating TCI states with the TRP 205-a and the TRP 205-b using a single DCI message. For example, the UE 115 may receive higher layer signaling (e.g., the control information 210 described with reference to FIG. 2) indicating a set of channels or reference signals to share the common TCI. In some examples, the UE 115-a may support various unified TCI states for multiple TRP operation. For instance, as described with reference to Table 1, the unified TCI states may include a joint TCI state, a downlink TCI state, or an uplink TCI state for downlink channels or reference signals and uplink channels or reference signals. In some examples, the various channels may be used to indicate the unified TCI states to the TRP 205-a and the TRP 205-b, respectively. In some cases, the UE 115 may apply a common TCI to a set of target channels which may be associated with a channel type (e.g., UE-dedicated PDCCH). Although Table 1 depicts a set of possibilities for target channels indicating a unified TCI state using a common TCI, the target channels which share a common TCI may depend on the set of channels configured to share the common TCI, as indicated in the control information 210. In other words, higher layer signaling (e.g., RRC signaling) may indicate whether each of the target channels indicated in Table 1 share the common TCI.

TABLE 1
Configurable Target Channels for a Common TCI

| Target Channels with a Common TCI | | Joint TCI | DL TCI | UL TCI |
|---|---|---|---|---|
| Downlink | UE-dedicated PDCCH | Yes | Yes | No |
| | UE-dedicated DG PDSCH | Yes | Yes | No |
| | CG PDSCH | Yes | Yes | No |
| | Non UE-dedicated | Yes | Yes | No |
| | PDDCH/PDSCH | | | |
| Uplink | UE-dedicated DG PUSCH | Yes | No | Yes |
| | CG PUSCH | Yes | No | Yes |
| | Dedicated PUSCH | Yes | No | Yes |

In some cases, if an uplink or downlink control channel (e.g., a PUCCH or PDCCH) is not configured with repetition, the channel may not share the common TCI indication. In such cases, the UE 115 may apply a separate TCI to the uplink or downlink channel configured without repetition. Additionally or alternatively, if an uplink data channel (e.g., a PUSCH) is not configured with repetition, the uplink data channel may not share the common TCI indication. Instead, the UE 115 may apply a separate scheduling request indication-based (SRI-based) beam indication to the uplink data channel configured without repetition. In some examples, the UE 115 may transmit a sounding reference signaling (SRS) to the TRP 205-a or the TRP 205-b, or both. The TRP 205-a or the TRP 205-b or both, may use the SRS to determine the quality of the communication channel. Resources for the SRS may be tagged with codebook (CB) based or non-codebook (NCB) based cases. In some aspects, the UE 115 may use the CB and NCB use cases for the SRS for uplink traffic, and such cases may be enabled to share a TCI indication.

As described with reference to Table 1, the UE 115 may apply a common TCI (e.g., a unified TCI 440-a) to a first channel group (or a first set of channels) configured to share the common TCI, and a separate TCI (e.g., a unified TCI 440-b) to a second channel group (or a second set of channels) including one or more channels not configured to share the common TCI. For instance, the first channel group may share the unified TCI 440-a. In some aspects, the first channel group may be associated with a first channel (e.g., a PDSCH 425-a) and a second channel (e.g., a PDSCH 425-c). In such cases, a first CORESET group associated with the first channel group may include a CORESET 420-a associated with the PDSCH 425-a and a CORESET 420-c associated with the PDSCH 425-c. Additionally or alternatively, a second channel group including one or more channels (e.g., a PDSCH 425-b) which are not configured to share the unified TCI 440-a may not share the unified TCI 440-b. In such cases, a second CORESET group associated with the one or more channels not sharing the unified TCI 440-a, may include a CORESET 420-b associated with the PDSCH 425-b.

In some examples, the unified TCI 440-a may be applied to PDSCH channels configured with repetitions and the unified TCI 440-b may be applied to one or more channels configured without repetition. For instance, the PDSCH 425-b may be a configured repetition of the PDSCH 425-a via frequency division multiplexing (FDM), and the PDSCH 425-c may not be a configured repetition. In some cases, based on receiving the CORESET 420-a and the CORESET 420-b, the UE 115 may receive scheduling resources which indicate the PDSCH 425-a and the PDSCH 425-b. Based on receiving the PDSCH 425-a and the PDSCH 425-b, the UE 115 may transmit a PUCCH 430-a and a PUCCH 430-b to the TRP 205-a and the TRP 205-b, respectively. In some examples, the PUCCH 430-a and the PUCCH 430-b may each contain an ACK response. In other cases, based on receiving the CORESET 420-c, the UE 115 may receive scheduling resources which indicate the PDSCH 425-c. Based on receiving the PDSCH 425-c, the UE 115 may transmit a PUCCH 430-c to one of the TRP 205-a or the TRP 205-b. In some examples, the PUCCH 430-c may include an ACK response.

In some cases, a PUSCH channel may be configured with repetitions via time division multiplexing (TDM). Additionally or alternatively, a PUSCH channel may not be configured with such repetitions. For example, a PUSCH 435-b may be a configured repetition of a PUSCH 435-a (a non-repetition) via TDM. However, a PUSCH 435-c may not be configured with repetitions. In such cases, the PUSCH 435-a and the PUSCH 435-c may not be repetitions, and the PUSCH 435-a and the PUSCH 435-c may belong to a channel group sharing the unified TCI 440-a (e.g., the first channel group mentioned previously). A CORESET group associated with the one or more channels not configured to share the unified TCI 440-a may include a CORESET 420-d associated with the PUSCH 435-a and a CORESET 420-f associated with the PUSCH 435-c. Additionally or alternatively, a different CORESET group associated with channels configured with repetitions may include a CORESET 420-e associated with the PUSCH 435-b.

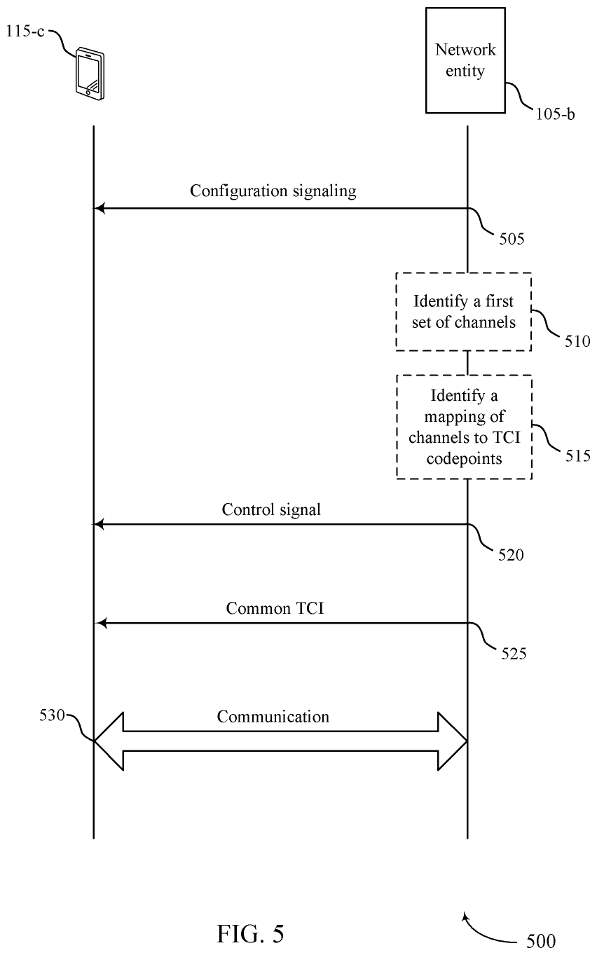

FIG. 5 illustrates an example of a process flow 500 that supports configurable channel types for unified TCI in accordance with one or more aspects of the present disclosure. In some examples, process flow 500 may be implemented by one or more aspects of wireless communications systems 100 and 200. For instance, a UE 115-c may be an example of a UE 115 as described with reference to FIG. 1 and a UE 115-a as described with reference to FIG. 2, and a network entity 105-b may be an example of a network entity 105 as described with reference to FIG. 1.

At 505, the network entity 105-b may output, and the UE 115-c may receive, configuration signaling. In some examples, the TRP 205-a may transmit the configuration signaling. Alternatively, the TRP 205-b may transmit the configuration signaling. The configuration signaling may identify a configuration for UE 115-c to communicate with the TRP 205-a and the TRP 205-b. The configuration may include the configuration for a list of TCI states (e.g., a joint TCI state, a downlink TCI state, an uplink TCI state), a number of TCI fields in a DCI, or both. For instance, the UE 115-c may receive RRC configuration for TCI states and the RRC configurations may configure TCI fields for a DCI.

At 510, the network entity 105-b may optionally identify a set of channels which may share a common TCI. The common TCI may indicate a first TCI state for the TRP 205-a and a second TCI state for the TRP 205-b. Additionally or alternatively, the network entity 105-b may identify at least one channel which corresponds to a second TCI which is different from the common TCI. In some examples, the second TCI may indicate one or multiple TCI states for the TRP 205-a, the TRP 205-b, or both. For instance, the network entity 105-b may identify a set of channels which share a common reference signal type. Accordingly, the network entity 105-b may configure the set of channels sharing the common reference signal type to also share the common TCI.

At 515, the network entity 105-b may optionally identify a mapping between one or more channels and one or more TCI codepoints associated with the common TCI, where the one or more TCI codepoints and TCI states corresponding to them may be activated by a MAC-CE. In some examples, the network entity 105-b may identify the mapping of a first TCI codepoint and one or more TCI states associated with a PDCCH and the mapping of a second TCI codepoint and one or more TCI states associated with a PDSCH. Additionally or alternatively, the network entity 105-b may identify the mapping between a TCI codepoint of a single unified TCI, where the single unified TCI indicates one or more TCI states for one or more channels configured without repetition. Additionally or alternatively, the network entity 105-b may identify a TCI codepoint of a set of unified TCIs, where the set of unified TCIs indicates the one or more TCI states for the one or more channels that are configured without repetition.

At 520, the network entity 105-b may output, and the UE 115-c may receive, a control signal (e.g., a downlink control message, such as a DCI) including control information. In some examples, the control signal may indicate the set of channels identified by the network entity 105-b to be associated with the common reference signal type and which share the common TCI by utilizing an RRC signaling or a MAC-CE signaling. In some aspects, the control signal may include a DCI which contains a first TCI field and a second TCI field. In some such examples, the first TCI field may indicate the first TCI state and the second TCI field may indicate the second TCI state. In some examples, each of the first field and the second field may indicate a respective joint TCI state, a downlink TCI state, or any combination thereof.

In other aspects, the control signal may include a DCI which includes a set of TCI codepoints. In some such examples, the control signal may indicate the mapping between one or more channels and one or more TCI codepoints associated with the common TCI, where the common TCI indicates a first TCI state for the TRP 205-a and the second TCI state for the TRP 205-b, as described with reference to FIG. 2. For instance, the control single may indicate the mapping of a first TCI codepoint and one or more TCI states associated with a PDCCH and the mapping of a second TCI codepoint and one or more TCI states associated with a PDSCH.

Additionally or alternatively, the control signal may indicate the TCI codepoint of a single unified TCI, where the single unified TCI indicates one or more TCI states for one or more channels configured without repetition. Additionally or alternatively, the network entity 105-b may indicate a TCI codepoint of a plurality of unified TCIs, where the plurality of unified TCIs indicates the one or more TCI states for the one or more channels that are configured without repetition.

At 525, the network entity 105-b may output, and the UE 115-c may receive, the common TCI. In some examples, the common TCI may be associated with the set of channels identified by the network entity 105-b to share the common TCI. As such, the common TCI may be applicable to such channels. In some examples, the common TCI may indicate the first TCI state for the TRP 205-a and the second TCI state for the TRP 205-b. Additionally or alternatively, the network entity 105-b may transmit, and the UE 115-c may receive, the second TCI. In some examples, the second TCI may be associated with the one or more channels identified by the network entity 105-b to share the second TCI. As a such, the second TCI may be applicable to such channels. The second TCI may be different from the common TCI. In such examples, the second TCI may indicate the one or more TCI states for the TRP 205-a, the TRP 205-b, or both.

At 530, the UE 115-c may communicate with the network entity 105-b according to the one or more TCIs (the common TCI or the second TCI) based on receiving the control information. That is, based on receiving the control information, the common TCI, and, in some cases, the second TCI, the UE 115-c may communicate with the TRP 205-a and the TRP 205-b. Additionally or alternatively, based on outputting the control information, the common TCI, and, in some cases, the second TCI, the TRP 205-a and the TRP 205-b may communicate with the UE 115-c. In some examples, performing the communicating may be based on receiving MAC-CE transmissions. In some examples, performing the communicating may also be based on receiving the MAC-CE transmissions.

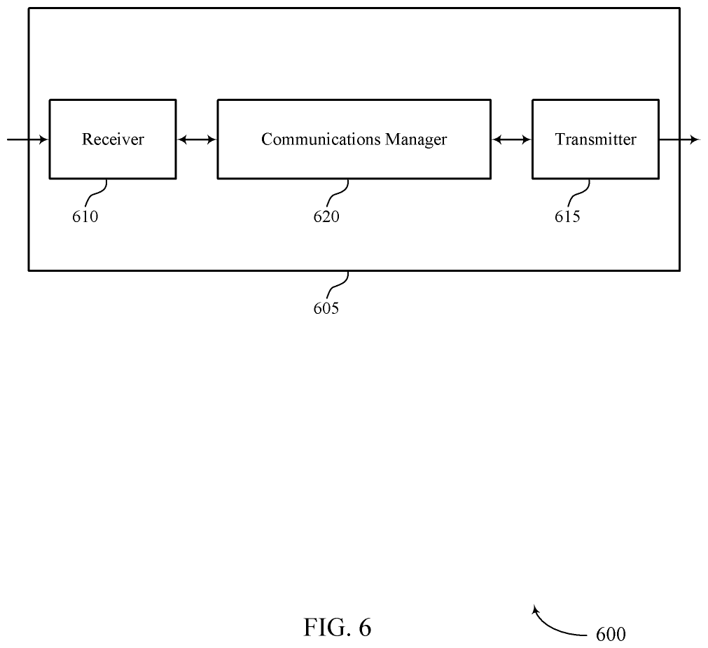

FIG. 6 shows a diagram 600 of a device 605 that supports configurable channel types for unified TCI in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to configurable channel types for unified TCI). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configurable channel types for unified TCI). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of configurable channel types for unified TCI as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving signaling indicating a configuration for the UE to communicate with a first TRP and a second TRP. The communications manager 620 may be configured as or otherwise support a means for receiving a control signal identifying a set of channels sharing a common TCI, the common TCI including a first TCI state for the first TRP and a second TCI state for the second TRP. The communications manager 620 may be configured as or otherwise support a means for communicating with at least one of the first TRP or the second TRP according to the common TCI based on the received control signal.

Additionally, or alternatively, the communications manager 620 may support wireless communication at a UE in accordance with examples as disclosed herein. For example, the communications manager 620 may be configured as or otherwise support a means for receiving signaling indicating a configuration for the UE to communicate with a first TRP and a second TRP. The communications manager 620 may be configured as or otherwise support a means for receiving a control signal identifying a mapping between one or more channels and one or more TCI codepoints associated with a common TCI, the common TCI indicating a first TCI state for the first TRP and a second TCI state for the second TRP. The communications manager 620 may be configured as or otherwise support a means for communicating with at least one of the first TRP or the second TRP according to the common TCI based on the received control signal.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for the device 605 to receive a unified TCI which may be applied to target channels associated with hybrid transmission and reception schemes for wireless communications between a UE 115 and mTRPs. Receiving the unified TCI which may be applied to target channels associated with hybrid transmission and reception schemes may provide for reduced latency for wireless communications as compared to receiving a unified TCI which may not be applied to target channels associated with hybrid transmission and reception schemes.

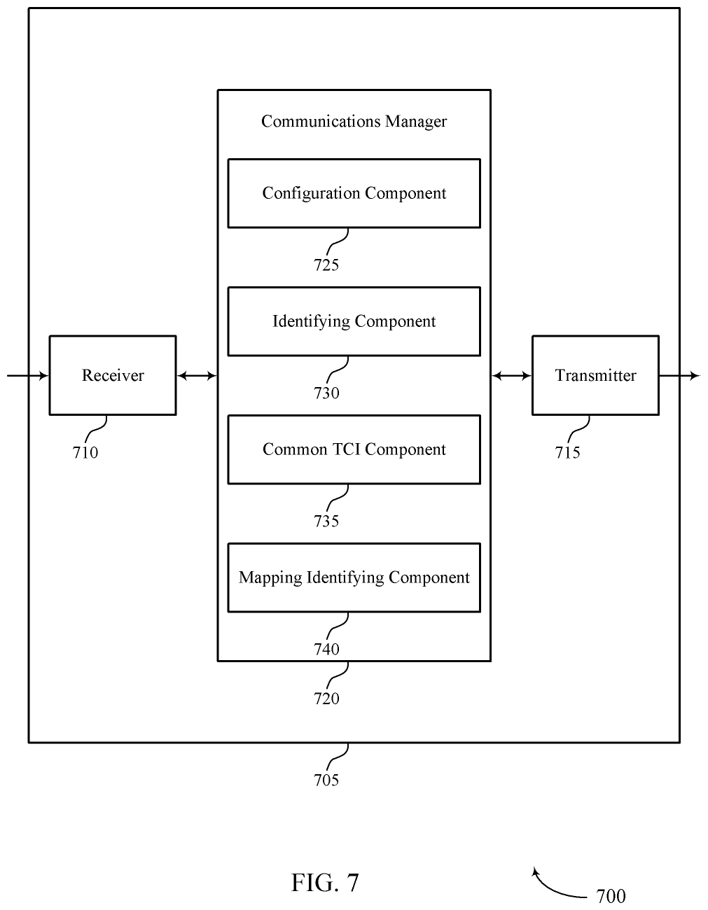

FIG. 7 shows a diagram 700 of a device 705 that supports configurable channel types for unified TCI in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to configurable channel types for unified TCI). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configurable channel types for unified TCI). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of configurable channel types for unified TCI as described herein. For example, the communications manager 720 may include a configuration component 725, an identifying component 730, a common TCI component 735, a mapping identifying component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The configuration component 725 may be configured as or otherwise support a means for receiving signaling indicating a configuration for the UE to communicate with a first TRP and a second TRP. The identifying component 730 may be configured as or otherwise support a means for receiving a control signal identifying a set of channels sharing a common TCI, the common TCI including a first TCI state for the first TRP and a second TCI state for the second TRP. The common TCI component 735 may be configured as or otherwise support a means for communicating with at least one of the first TRP or the second TRP according to the common TCI based on the received control signal.

Additionally, or alternatively, the communications manager 720 may support wireless communication at a UE in accordance with examples as disclosed herein. The configuration component 725 may be configured as or otherwise support a means for receiving signaling indicating a configuration for the UE to communicate with a first TRP and a second TRP. The mapping identifying component 740 may be configured as or otherwise support a means for receiving a control signal identifying a mapping between one or more channels and one or more TCI codepoints associated with a common TCI, the common TCI indicating a first TCI state for the first TRP and a second TCI state for the second TRP. The common TCI component 735 may be configured as or otherwise support a means for communicating with at least one of the first TRP or the second TRP according to the common TCI based on the received control signal.

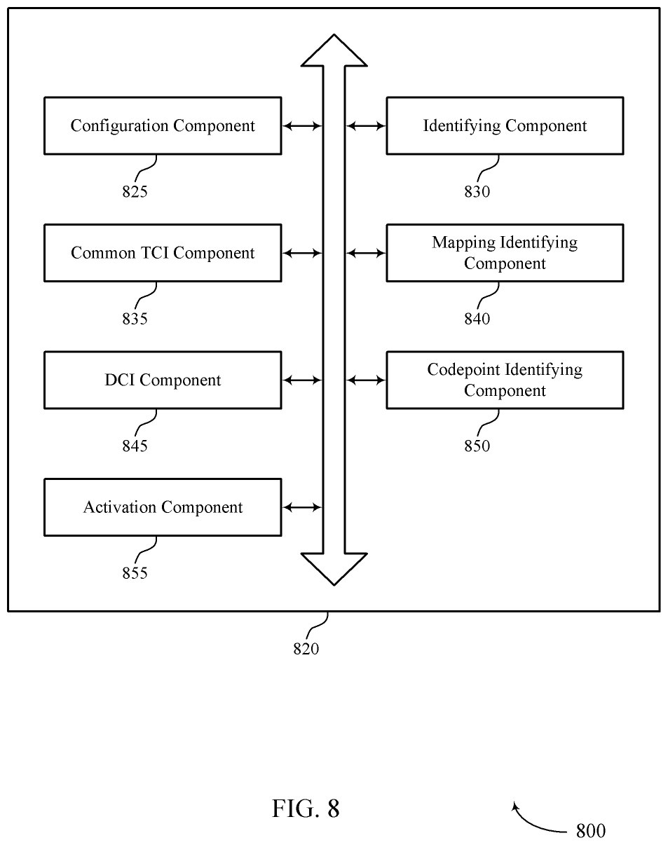

FIG. 8 shows a diagram 800 of a communications manager 820 that supports configurable channel types for unified TCI in accordance with one or more aspects of the present disclosure. The communications manager 820 may be an example of aspects of a communications manager 620, a communications manager 720, or both, as described herein. The communications manager 820, or various components thereof, may be an example of means for performing various aspects of configurable channel types for unified TCI as described herein. For example, the communications manager 820 may include a configuration component 825, an identifying component 830, a common TCI component 835, a mapping identifying component 840, a DCI component 845, a codepoint identifying component 850, an activation component 855, or any combination thereof. Each of these components may communicate, directly or indirectly, with one another (e.g., via one or more buses).

The communications manager 820 may support wireless communication at a UE in accordance with examples as disclosed herein. The configuration component 825 may be configured as or otherwise support a means for receiving signaling indicating a configuration for the UE to communicate with a first TRP and a second TRP. The identifying component 830 may be configured as or otherwise support a means for receiving a control signal identifying a set of channels sharing a common TCI, the common TCI including a first TCI state for the first TRP and a second TCI state for the second TRP. The common TCI component 835 may be configured as or otherwise support a means for communicating with at least one of the first TRP or the second TRP according to the common TCI based on the received control signal.

In some examples, to support receiving the control signal, the identifying component 830 may be configured as or otherwise support a means for receiving the control signal identifying at least one channel associated with a second TCI indicating one or more TCI states for the first TRP, the second TRP, or both, where the second TCI is different from the common TCI.

In some examples, to support receiving the control signal, the identifying component 830 may be configured as or otherwise support a means for receiving the control signal identifying at least one reference signal type associated with a second TCI indicating one or more TCI states for the first TRP, the second TRP, or both, where the second TCI is different from the common TCI.

In some examples, to support receiving the control signal, the identifying component 830 may be configured as or otherwise support a means for receiving the control signal indicating that the set of channels associated with a common reference signal type shares the common TCI.

In some examples, the DCI component 845 may be configured as or otherwise support a means for receiving a downlink control information including a first TCI field and a second TCI field, where the first TCI field indicates the first TCI state, and the second TCI field indicates the second TCI state.

In some examples, the first TCI state, the second TCI state, or both include at least one of a respective joint TCI state, a downlink TCI state, an uplink TCI state, or any combination thereof.

In some examples, the set of channels includes at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

In some examples, the control signal includes a radio resource control signaling or medium access control (MAC) control element (MAC-CE) signaling indicating the set of channels.

Additionally, or alternatively, the communications manager 820 may support wireless communication at a UE in accordance with examples as disclosed herein. In some examples, the configuration component 825 may be configured as or otherwise support a means for receiving signaling indicating a configuration for the UE to communicate with a first TRP and a second TRP. The mapping identifying component 840 may be configured as or otherwise support a means for receiving a control signal identifying a mapping between one or more channels and one or more TCI codepoints associated with a common TCI, the common TCI indicating a first TCI state for the first TRP and a second TCI state for the second TRP. In some examples, the common TCI component 835 may be configured as or otherwise support a means for communicating with at least one of the first TRP or the second TRP according to the common TCI based on the received control signal.

In some examples, to support receiving the control signal, the mapping identifying component 840 may be configured as or otherwise support a means for receiving the control signal identifying the mapping between the one or more channels and a TCI field included in the common TCI.

In some examples, to support receiving the control signal, the mapping identifying component 840 may be configured as or otherwise support a means for receiving the control signal identifying the mapping between a first TCI codepoint and one or more TCIs associated with a physical downlink control channel and the mapping between a second TCI codepoint and one or more TCIs associated with a physical downlink shared channel.

In some examples, to support receiving the control signal, the codepoint identifying component 850 may be configured as or otherwise support a means for receiving the control signal identifying a TCI codepoint of a single unified TCI, where the single unified TCI indicates one or more TCI states for one or more channels configured without repetition.

In some examples, to support receiving the control signal, the codepoint identifying component 850 may be configured as or otherwise support a means for receiving the control signal identifying a TCI codepoint of a set of multiple unified TCIs, where the set of multiple unified TCI indicates one or more TCI states for one or more channels configured with repetition.

In some examples, the DCI component 845 may be configured as or otherwise support a means for receiving a downlink control information message including a first TCI field and a second TCI field, the first TCI field indicating one or more TCI states for a physical downlink control channel, and the second TCI field indicating one or more TCI states for a physical downlink shared channel.

In some examples, the activation component 855 may be configured as or otherwise support a means for receiving a first medium access control (MAC) control element (MAC-CE) activating the first TCI state for the first TRP, where communicating with the first TRP is based on receiving the first MAC-CE. In some examples, the activation component 855 may be configured as or otherwise support a means for receiving a second MAC-CE activating the second TCI state for the second TRP, where communicating with the second TRP is based on receiving the second MAC-CE.

In some examples, the first TCI state, the second TCI state, or both include at least one of a respective joint TCI state, a downlink TCI state, an uplink TCI state, or any combination thereof.

In some examples, the control signal includes a radio resource control signaling or medium access control (MAC) control element (MAC-CE) signaling indicating the one or more channels.

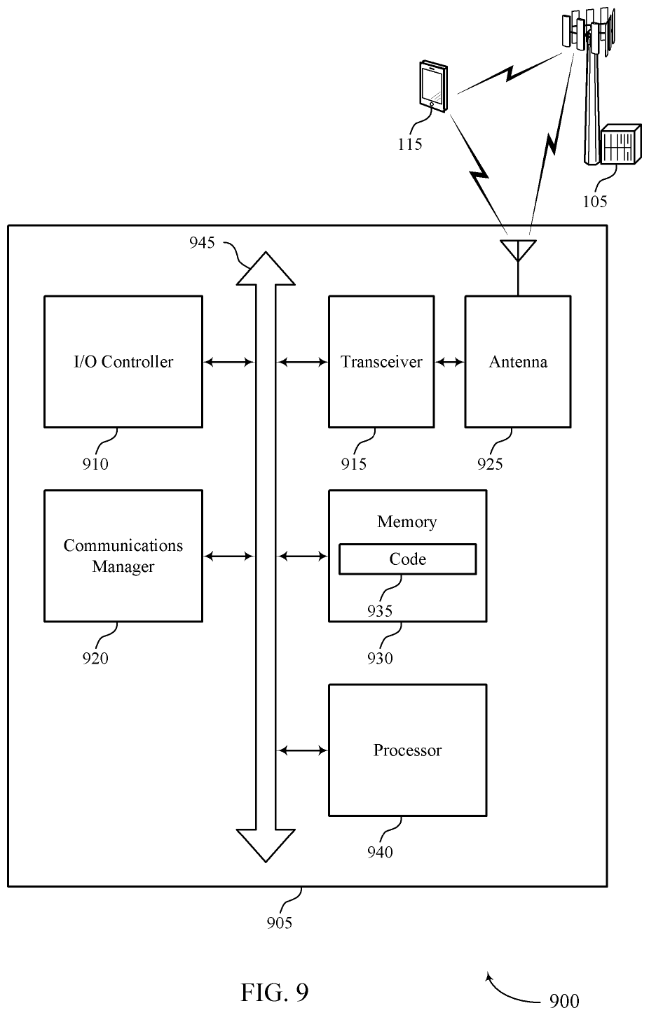

FIG. 9 shows a diagram of a system 900 including a device 905 that supports configurable channel types for unified TCI in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting configurable channel types for unified TCI). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving signaling indicating a configuration for the UE to communicate with a first TRP and a second TRP. The communications manager 920 may be configured as or otherwise support a means for receiving a control signal identifying a set of channels sharing a common TCI, the common TCI including a first TCI state for the first TRP and a second TCI state for the second TRP. The communications manager 920 may be configured as or otherwise support a means for communicating with at least one of the first TRP or the second TRP according to the common TCI based on the received control signal.

Additionally, or alternatively, the communications manager 920 may support wireless communication at a UE in accordance with examples as disclosed herein. For example, the communications manager 920 may be configured as or otherwise support a means for receiving signaling indicating a configuration for the UE to communicate with a first TRP and a second TRP. The communications manager 920 may be configured as or otherwise support a means for receiving a control signal identifying a mapping between one or more channels and one or more TCI codepoints associated with a common TCI, the common TCI indicating a first TCI state for the first TRP and a second TCI state for the second TRP. The communications manager 920 may be configured as or otherwise support a means for communicating with at least one of the first TRP or the second TRP according to the common TCI based on the received control signal.

By including or configuring the communications manager 920 in accordance with examples as described herein, the device 905 may support techniques for the device 905 to receive a unified TCI which may be applied to target channels associated with hybrid transmission and reception schemes for wireless communications between a UE 115 and mTRPs. Receiving the unified TCI which may be applied to target channels associated with hybrid transmission and reception schemes may provide for reduced latency for wireless communications compared to receiving a unified TCI which may not be applied to target channels associated with hybrid transmission and reception schemes. Additionally, receiving the unified TCI which may be applied to target channels associated with hybrid transmission and reception schemes may provide for improved coordination between the UE 115 and the mTRPs because the UE 115 may be aware of the TCI states which correspond to the respective target channels.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of configurable channel types for unified TCI as described herein, or the processor 940 and the memory 930 may be otherwise configured to perform or support such operations.

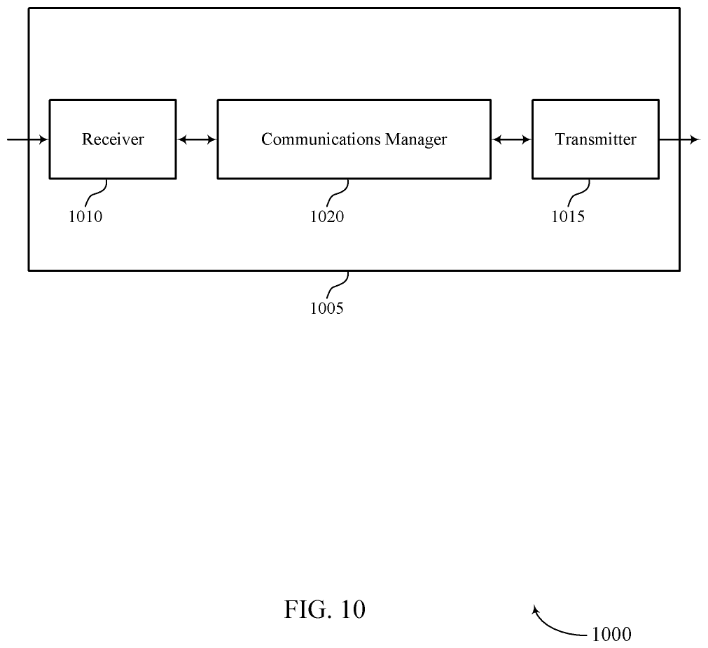

FIG. 10 shows a diagram 1000 of a device 1005 that supports configurable channel types for unified TCI in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of configurable channel types for unified TCI as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for outputting signaling indicating a configuration for a UE to communicate with a first TRP and a second TRP. The communications manager 1020 may be configured as or otherwise support a means for outputting a control signal identifying a set of channels sharing a common TCI, the common TCI indicating a first TCI state for the first TRP and a second TCI state for the second TRP. The communications manager 1020 may be configured as or otherwise support a means for communicating with the UE according to the common TCI based on outputting the control signal.

Additionally, or alternatively, the communications manager 1020 may support wireless communication at a network entity in accordance with examples as disclosed herein. For example, the communications manager 1020 may be configured as or otherwise support a means for outputting signaling indicating a configuration for a UE to communicate with a first TRP and a second TRP. The communications manager 1020 may be configured as or otherwise support a means for outputting a control signal identifying a mapping between one or more channels and one or more TCI codepoints associated with a common TCI, the common TCI indicating a first TCI state for the first TRP and a second TCI state for the second TRP. The communications manager 1020 may be configured as or otherwise support a means for communicating with the UE according to the common TCI based on receiving the control signal.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for the device 1005 to receive a unified TCI which may be applied to target channels associated with hybrid transmission and reception schemes for wireless communications between a UE 115 and mTRPs. Receiving the unified TCI which may be applied to target channels associated with hybrid transmission and reception schemes may provide for reduced latency for wireless communications compared to receiving a unified TCI which may not be applied to target channels associated with hybrid transmission and reception schemes.

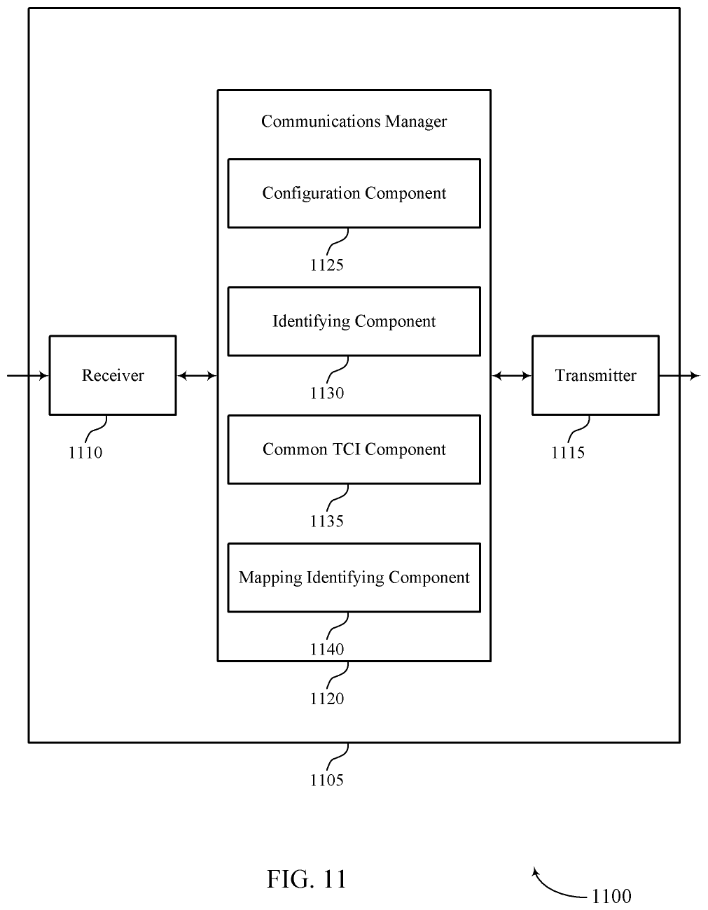

FIG. 11 shows a diagram 1100 of a device 1105 that supports configurable channel types for unified TCI in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of configurable channel types for unified TCI as described herein. For example, the communications manager 1120 may include a configuration component 1125, an identifying component 1130, a common TCI component 1135, a mapping identifying component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The configuration component 1125 may be configured as or otherwise support a means for outputting signaling indicating a configuration for a UE to communicate with a first TRP and a second TRP. The identifying component 1130 may be configured as or otherwise support a means for outputting a control signal identifying a set of channels sharing a common TCI, the common TCI indicating a first TCI state for the first TRP and a second TCI state for the second TRP. The common TCI component 1135 may be configured as or otherwise support a means for communicating with the UE according to the common TCI based on outputting the control signal.

Additionally, or alternatively, the communications manager 1120 may support wireless communication at a network entity in accordance with examples as disclosed herein. The configuration component 1125 may be configured as or otherwise support a means for outputting signaling indicating a configuration for a UE to communicate with a first TRP and a second TRP. The mapping identifying component 1140 may be configured as or otherwise support a means for outputting a control signal identifying a mapping between one or more channels and one or more TCI codepoints associated with a common TCI, the common TCI indicating a first TCI state for the first TRP and a second TCI state for the second TRP. The common TCI component 1135 may be configured as or otherwise support a means for communicating with the UE according to the common TCI based on receiving the control signal.

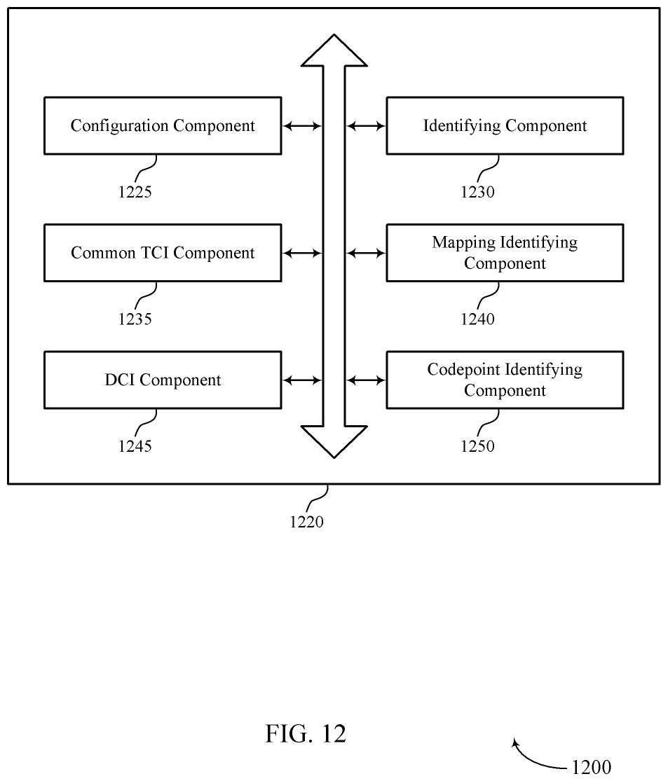

FIG. 12 shows a diagram 1200 of a communications manager 1220 that supports configurable channel types for unified TCI in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of configurable channel types for unified TCI as described herein. For example, the communications manager 1220 may include a configuration component 1225, an identifying component 1230, a common TCI component 1235, a mapping identifying component 1240, a DCI component 1245, a codepoint identifying component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The configuration component 1225 may be configured as or otherwise support a means for outputting signaling indicating a configuration for a UE to communicate with a first TRP and a second TRP. The identifying component 1230 may be configured as or otherwise support a means for outputting a control signal identifying a set of channels sharing a common TCI, the common TCI indicating a first TCI state for the first TRP and a second TCI state for the second TRP. The common TCI component 1235 may be configured as or otherwise support a means for communicating with the UE according to the common TCI based on outputting the control signal.

In some examples, to support outputting the control signal, the identifying component 1230 may be configured as or otherwise support a means for outputting the control signal identifying at least one channel associated with a second TCI indicating one or more TCI states for the first TRP, the second TRP, or both, where the second TCI is different from the common TCI.

In some examples, to support outputting the control signal, the identifying component 1230 may be configured as or otherwise support a means for outputting the control signal identifying at least one reference signal type associated with a second TCI indicating one or more TCI states for the first TRP, the second TRP, or both, where the second TCI is different from the common TCI.

In some examples, to support outputting the control signal, the identifying component 1230 may be configured as or otherwise support a means for outputting the control signal indicating that the set of channels associated with a common reference signal type shares the common TCI.

In some examples, the DCI component 1245 may be configured as or otherwise support a means for outputting a downlink control information including a first TCI field and a second TCI field, where the first TCI field indicates the first TCI state, and the second TCI field indicates the second TCI state.

In some examples, the first TCI state, the second TCI state, or both include at least one of a respective joint TCI state, a downlink TCI state, an uplink TCI state, or any combination thereof.

In some examples, the set of channels includes at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

In some examples, the control signal includes a radio resource control signaling or medium access control (MAC) control element (MAC-CE) signaling indicating the set of channels.

Additionally, or alternatively, the communications manager 1220 may support wireless communication at a network entity in accordance with examples as disclosed herein. In some examples, the configuration component 1225 may be configured as or otherwise support a means for outputting signaling indicating a configuration for a UE to communicate with a first TRP and a second TRP. The mapping identifying component 1240 may be configured as or otherwise support a means for outputting a control signal identifying a mapping between one or more channels and one or more TCI codepoints associated with a common TCI, the common TCI indicating a first TCI state for the first TRP and a second TCI state for the second TRP. In some examples, the common TCI component 1235 may be configured as or otherwise support a means for communicating with the UE according to the common TCI based on receiving the control signal.

In some examples, to support outputting the control signal, the mapping identifying component 1240 may be configured as or otherwise support a means for outputting the control signal identifying the mapping between the one or more channels and a TCI field included in the common TCI.

In some examples, to support outputting the control signal, the mapping identifying component 1240 may be configured as or otherwise support a means for outputting the control signal identifying the mapping between a first TCI codepoint and one or more TCIs associated with a physical downlink control channel and the mapping between a second TCI codepoint and one or more TCIs associated with a physical downlink shared channel.

In some examples, to support outputting the control signal, the codepoint identifying component 1250 may be configured as or otherwise support a means for outputting the control signal identifying a TCI codepoint of a single unified TCI, where the single unified TCI indicates one or more TCI states for one or more channels configured without repetition.

In some examples, to support outputting the control signal, the codepoint identifying component 1250 may be configured as or otherwise support a means for outputting the control signal identifying a TCI codepoint of a set of multiple unified TCIs, where the set of multiple unified TCI indicates one or more TCI states for one or more channels configured with repetition.

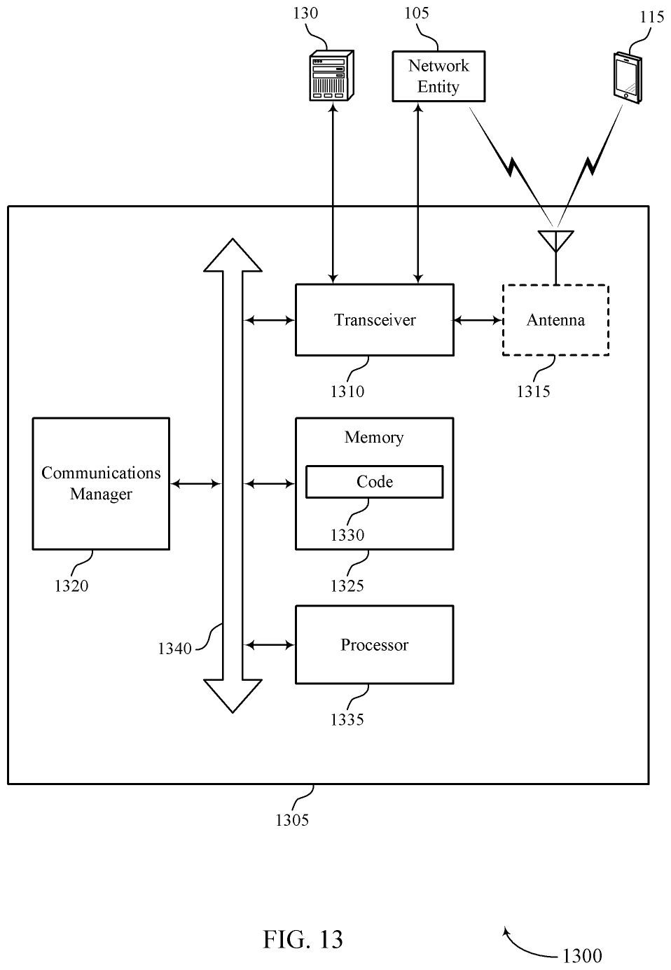

FIG. 13 shows a diagram of a system 1300 including a device 1305 that supports configurable channel types for unified TCI in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting configurable channel types for unified TCI). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for outputting signaling indicating a configuration for a UE to communicate with a first TRP and a second TRP. The communications manager 1320 may be configured as or otherwise support a means for outputting a control signal identifying a set of channels sharing a common TCI, the common TCI indicating a first TCI state for the first TRP and a second TCI state for the second TRP. The communications manager 1320 may be configured as or otherwise support a means for communicating with the UE according to the common TCI based on outputting the control signal.

Additionally, or alternatively, the communications manager 1320 may support wireless communication at a network entity in accordance with examples as disclosed herein. For example, the communications manager 1320 may be configured as or otherwise support a means for outputting signaling indicating a configuration for a UE to communicate with a first TRP and a second TRP. The communications manager 1320 may be configured as or otherwise support a means for outputting a control signal identifying a mapping between one or more channels and one or more TCI codepoints associated with a common TCI, the common TCI indicating a first TCI state for the first TRP and a second TCI state for the second TRP. The communications manager 1320 may be configured as or otherwise support a means for communicating with the UE according to the common TCI based on receiving the control signal.

By including or configuring the communications manager 1320 in accordance with examples as described herein, the device 1305 may support techniques for the device 1305 to receive a unified TCI which may be applied to target channels associated with hybrid transmission and reception schemes for wireless communications between a UE 115 and mTRPs. Receiving the unified TCI which may be applied to target channels associated with hybrid transmission and reception schemes may provide for reduced latency for wireless communications compared to receiving a unified TCI which may not be applied to target channels associated with hybrid transmission and reception schemes. Additionally, receiving the unified TCI which may be applied to target channels associated with hybrid transmission and reception schemes may provide for improved coordination between the UE 115 and the mTRPs because the UE 115 may be aware of the TCI states which correspond to the respective target channels.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of configurable channel types for unified TCI as described herein, or the processor 1335 and the memory 1325 may be otherwise configured to perform or support such operations.

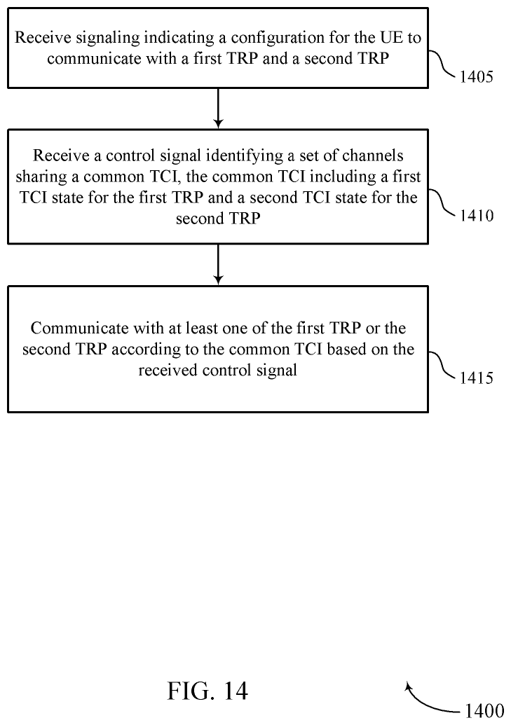

FIG. 14 shows a flowchart illustrating a method 1400 that supports configurable channel types for unified TCI in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving signaling indicating a configuration for the UE to communicate with a first TRP and a second TRP. The operations of 1405 may be performed in accordance with examples as disclosed herein. In some examples, aspects of the operations of 1405 may be performed by a configuration component 825 as described with reference to FIG. 8.

At 1410, the method may include receiving a control signal identifying a set of channels sharing a common TCI, the common TCI including a first TCI state for the first TRP and a second TCI state for the second TRP. The operations of 1410 may be performed in accordance with examples as disclosed herein. In some examples, aspects of the operations of 1410 may be performed by an identifying component 830 as described with reference to FIG. 8.

At 1415, the method may include communicating with at least one of the first TRP or the second TRP according to the common TCI based on the received control signal. The operations of 1415 may be performed in accordance with examples as disclosed herein. In some examples, aspects of the operations of 1415 may be performed by a common TCI component 835 as described with reference to FIG. 8.

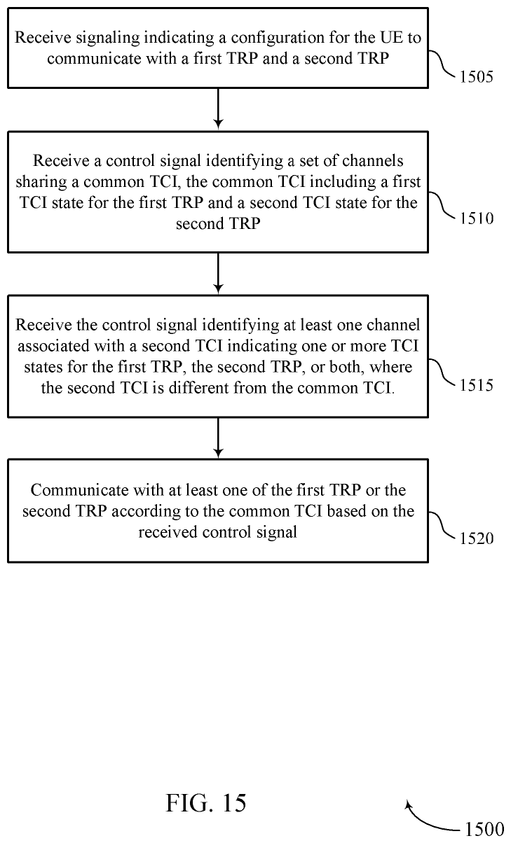

FIG. 15 shows a flowchart illustrating a method 1500 that supports configurable channel types for unified TCI in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving signaling indicating a configuration for the UE to communicate with a first TRP and a second TRP. The operations of 1505 may be performed in accordance with examples as disclosed herein. In some examples, aspects of the operations of 1505 may be performed by a configuration component 825 as described with reference to FIG. 8.

At 1510, the method may include receiving a control signal identifying a set of channels sharing a common TCI, the common TCI including a first TCI state for the first TRP and a second TCI state for the second TRP. The operations of 1510 may be performed in accordance with examples as disclosed herein. In some examples, aspects of the operations of 1510 may be performed by an identifying component 830 as described with reference to FIG. 8.

At 1515, the method may include receiving the control signal identifying at least one channel associated with a second TCI indicating one or more TCI states for the first TRP, the second TRP, or both, where the second TCI is different from the common TCI. The operations of 1515 may be performed in accordance with examples as disclosed herein. In some examples, aspects of the operations of 1515 may be performed by an identifying component 830 as described with reference to FIG. 8.

At 1520, the method may include communicating with at least one of the first TRP or the second TRP according to the common TCI based on the received control signal. The operations of 1520 may be performed in accordance with examples as disclosed herein. In some examples, aspects of the operations of 1520 may be performed by a common TCI component 835 as described with reference to FIG. 8.

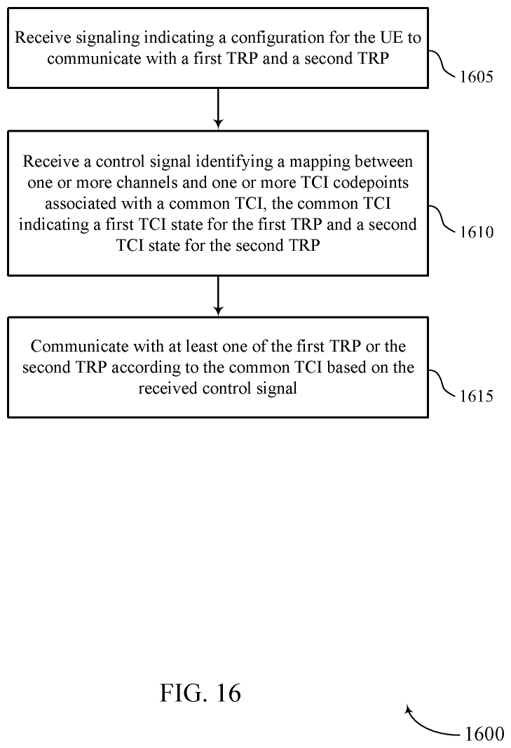

FIG. 16 shows a flowchart illustrating a method 1600 that supports configurable channel types for unified TCI in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving signaling indicating a configuration for the UE to communicate with a first TRP and a second TRP. The operations of 1605 may be performed in accordance with examples as disclosed herein. In some examples, aspects of the operations of 1605 may be performed by a configuration component 825 as described with reference to FIG. 8.

At 1610, the method may include receiving a control signal identifying a mapping between one or more channels and one or more TCI codepoints associated with a common TCI, the common TCI indicating a first TCI state for the first TRP and a second TCI state for the second TRP. The operations of 1610 may be performed in accordance with examples as disclosed herein. In some examples, aspects of the operations of 1610 may be performed by a mapping identifying component 840 as described with reference to FIG. 8.

At 1615, the method may include communicating with at least one of the first TRP or the second TRP according to the common TCI based on the received control signal. The operations of 1615 may be performed in accordance with examples as disclosed herein. In some examples, aspects of the operations of 1615 may be performed by a common TCI component 835 as described with reference to FIG. 8.

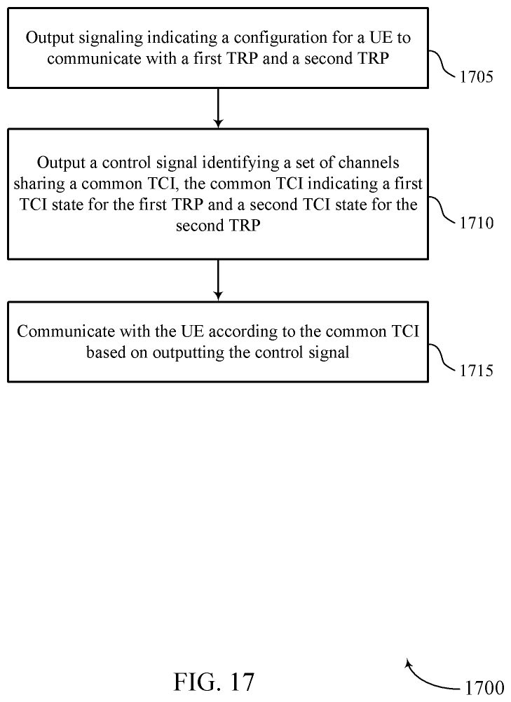

FIG. 17 shows a flowchart illustrating a method 1700 that supports configurable channel types for unified TCI in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting signaling indicating a configuration for a UE to communicate with a first TRP and a second TRP. The operations of 1705 may be performed in accordance with examples as disclosed herein. In some examples, aspects of the operations of 1705 may be performed by a configuration component 1225 as described with reference to FIG. 12.

At 1710, the method may include outputting a control signal identifying a set of channels sharing a common TCI, the common TCI indicating a first TCI state for the first TRP and a second TCI state for the second TRP. The operations of 1710 may be performed in accordance with examples as disclosed herein. In some examples, aspects of the operations of 1710 may be performed by an identifying component 1230 as described with reference to FIG. 12.

At 1715, the method may include communicating with the UE according to the common TCI based on outputting the control signal. The operations of 1715 may be performed in accordance with examples as disclosed herein. In some examples, aspects of the operations of 1715 may be performed by a common TCI component 1235 as described with reference to FIG. 12.

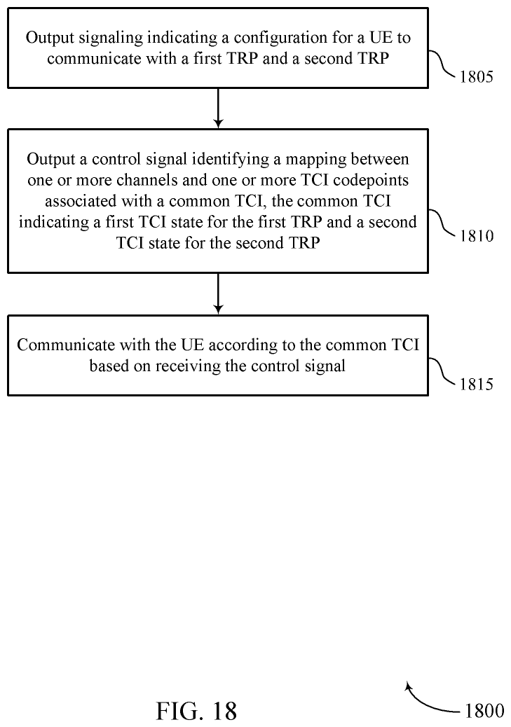

FIG. 18 shows a flowchart illustrating a method 1800 that supports configurable channel types for unified TCI in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting signaling indicating a configuration for a UE to communicate with a first TRP and a second TRP. The operations of 1805 may be performed in accordance with examples as disclosed herein. In some examples, aspects of the operations of 1805 may be performed by a configuration component 1225 as described with reference to FIG. 12.

At 1810, the method may include outputting a control signal identifying a mapping between one or more channels and one or more TCI codepoints associated with a common TCI, the common TCI indicating a first TCI state for the first TRP and a second TCI state for the second TRP. The operations of 1810 may be performed in accordance with examples as disclosed herein. In some examples, aspects of the operations of 1810 may be performed by a mapping identifying component 1240 as described with reference to FIG. 12.

At 1815, the method may include communicating with the UE according to the common TCI based on receiving the control signal. The operations of 1815 may be performed in accordance with examples as disclosed herein. In some examples, aspects of the operations of 1815 may be performed by a common TCI component 1235 as described with reference to FIG. 12.

The following provides an overview of aspects of the present disclosure:

Aspect 1: A method for wireless communication at a UE, comprising: receiving signaling indicating a configuration for the UE to communicate with a first transmission reception point and a second transmission reception point; receiving a control signal identifying a set of channels sharing a common transmission configuration indication, the common transmission configuration indication comprising a first transmission configuration indicator state for the first transmission reception point and a second transmission configuration indicator state for the second transmission reception point; and communicating with at least one of the first transmission reception point or the second transmission reception point according to the common transmission configuration indication based at least in part on the received control signal.

Aspect 2: The method of aspect 1, wherein receiving the control signal further comprises: receiving the control signal identifying at least one channel associated with a second transmission configuration indication indicating one or more transmission configuration indicator states for the first transmission reception point, the second transmission reception point, or both, wherein the second transmission configuration indication is different from the common transmission configuration indication.

Aspect 3: The method of any of aspects 1 through 2, wherein receiving the control signal further comprises: receiving the control signal identifying at least one reference signal type associated with a second transmission configuration indication indicating one or more transmission configuration indicator states for the first transmission reception point, the second transmission reception point, or both, wherein the second transmission configuration indication is different from the common transmission configuration indication.

Aspect 4: The method of any of aspects 1 through 3, wherein receiving the control signal further comprises: receiving the control signal indicating that the set of channels associated with a common reference signal type shares the common transmission configuration indication.

Aspect 5: The method of any of aspects 1 through 4, further comprising: receiving a downlink control information comprising a first transmission configuration indication field and a second transmission configuration indication field, wherein the first transmission configuration indication field indicates the first transmission configuration indication state, and the second transmission configuration indication field indicates the second transmission configuration indication state.

Aspect 6: The method of any of aspects 1 through 5, wherein the first transmission configuration indicator state, the second transmission configuration indicator state, or both comprise at least one of a respective joint transmission configuration indicator state, a downlink transmission configuration indicator state, an uplink transmission configuration indicator state, or any combination thereof.

Aspect 7: The method of any of aspects 1 through 6, wherein the set of channels comprises at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

Aspect 8: The method of any of aspects 1 through 7, wherein the control signal comprises a radio resource control signaling or medium access control (MAC) control element (MAC-CE) signaling indicating the set of channels.

Aspect 9: A method for wireless communication at a UE, comprising: receiving signaling indicating a configuration for the UE to communicate with a first transmission reception point and a second transmission reception point; receiving a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point; and communicating with at least one of the first transmission reception point or the second transmission reception point according to the common transmission configuration indication based at least in part on the received control signal.

Aspect 10: The method of aspect 9, wherein receiving the control signal further comprises: receiving the control signal identifying the mapping between the one or more channels and a transmission configuration indication field included in the common transmission configuration indication.

Aspect 11: The method of any of aspects 9 through 10, wherein receiving the control signal further comprises: receiving the control signal identifying the mapping between a first transmission configuration indication codepoint and one or more transmission configuration indications associated with a physical downlink control channel and the mapping between a second transmission configuration indication codepoint and one or more transmission configuration indications associated with a physical downlink shared channel.

Aspect 12: The method of any of aspects 9 through 11, wherein receiving the control signal further comprises: receiving the control signal identifying a transmission configuration indication codepoint of a single unified transmission configuration indication, wherein the single unified transmission configuration indication indicates one or more transmission configuration indication states for one or more channels configured without repetition.

Aspect 13: The method of any of aspects 9 through 12, wherein receiving the control signal further comprises: receiving the control signal identifying a transmission configuration indication codepoint of a plurality of unified transmission configuration indications, wherein the plurality of unified transmission configuration indication indicates one or more transmission configuration indication states for one or more channels configured with repetition.

Aspect 14: The method of any of aspects 9 through 13, further comprising: receiving a downlink control information message comprising a first transmission configuration indication field and a second transmission configuration indication field, the first transmission configuration indication field indicating one or more transmission configuration indication states for a physical downlink control channel, and the second transmission configuration indication field indicating one or more transmission configuration indication states for a physical downlink shared channel.

Aspect 15: The method of any of aspects 9 through 14, further comprising: receiving a first medium access control (MAC) control element (MAC-CE) activating the first transmission configuration indicator state for the first transmission reception point, wherein communicating with the first transmission reception point is based at least in part on receiving the first MAC-CE; and receiving a second MAC-CE activating the second transmission configuration indicator state for the second transmission reception point, wherein communicating with the second transmission reception point is based at least in part on receiving the second MAC-CE.

Aspect 16: The method of any of aspects 9 through 15, wherein the first transmission configuration indicator state, the second transmission configuration indicator state, or both comprise at least one of a respective joint transmission configuration indicator state, a downlink transmission configuration indicator state, an uplink transmission configuration indicator state, or any combination thereof.

Aspect 17: The method of any of aspects 9 through 16, wherein the control signal comprises a radio resource control signaling or medium access control (MAC) control element (MAC-CE) signaling indicating the one or more channels.

Aspect 18: A method for wireless communication at a network entity, comprising: outputting signaling indicating a configuration for a UE to communicate with a first transmission reception point and a second transmission reception point; outputting a control signal identifying a set of channels sharing a common transmission configuration indication, the common transmission configuration indication indicating a first transmission configuration indicator state for the first transmission reception point and a second transmission configuration indicator state for the second transmission reception point; and communicating with the UE according to the common transmission configuration indication based at least in part on outputting the control signal.

Aspect 19: The method of aspect 18, wherein outputting the control signal further comprises: outputting the control signal identifying at least one channel associated with a second transmission configuration indication indicating one or more transmission configuration indicator states for the first transmission reception point, the second transmission reception point, or both, wherein the second transmission configuration indication is different from the common transmission configuration indication.

Aspect 20: The method of any of aspects 18 through 19, wherein outputting the control signal further comprises: outputting the control signal identifying at least one reference signal type associated with a second transmission configuration indication indicating one or more transmission configuration indicator states for the first transmission reception point, the second transmission reception point, or both, wherein the second transmission configuration indication is different from the common transmission configuration indication.

Aspect 21: The method of any of aspects 18 through 20, wherein outputting the control signal further comprises: outputting the control signal indicating that the set of channels associated with a common reference signal type shares the common transmission configuration indication.

Aspect 22: The method of any of aspects 18 through 21, further comprising: outputting a downlink control information comprising a first transmission configuration indication field and a second transmission configuration indication field, wherein the first transmission configuration indication field indicates the first transmission configuration indication state, and the second transmission configuration indication field indicates the second transmission configuration indication state.

Aspect 23: The method of any of aspects 18 through 22, wherein the first transmission configuration indicator state, the second transmission configuration indicator state, or both comprise at least one of a respective joint transmission configuration indicator state, a downlink transmission configuration indicator state, an uplink transmission configuration indicator state, or any combination thereof.

Aspect 24: The method of any of aspects 18 through 23, wherein the set of channels comprises at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

Aspect 25: The method of any of aspects 18 through 24, wherein the control signal comprises a radio resource control signaling or medium access control (MAC) control element (MAC-CE) signaling indicating the set of channels.

Aspect 26: A method for wireless communication at a network entity, comprising: outputting signaling indicating a configuration for a UE to communicate with a first transmission reception point and a second transmission reception point; outputting a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point; and communicating with the UE according to the common transmission configuration indication based at least in part on receiving the control signal.

Aspect 27: The method of aspect 26, wherein outputting the control signal further comprises: outputting the control signal identifying the mapping between the one or more channels and a transmission configuration indication field included in the common transmission configuration indication.

Aspect 28: The method of any of aspects 26 through 27, wherein outputting the control signal further comprises: outputting the control signal identifying the mapping between a first transmission configuration indication codepoint and one or more transmission configuration indications associated with a physical downlink control channel and the mapping between a second transmission configuration indication codepoint and one or more transmission configuration indications associated with a physical downlink shared channel.

Aspect 29: The method of any of aspects 26 through 28, wherein outputting the control signal further comprises: outputting the control signal identifying a transmission configuration indication codepoint of a single unified transmission configuration indication, wherein the single unified transmission configuration indication indicates one or more transmission configuration indication states for one or more channels configured without repetition.

Aspect 30: The method of any of aspects 26 through 29, wherein outputting the control signal further comprises: outputting the control signal identifying a transmission configuration indication codepoint of a plurality of unified transmission configuration indications, wherein the plurality of unified transmission configuration indication indicates one or more transmission configuration indication states for one or more channels configured with repetition.

Aspect 31: An apparatus for wireless communication at a UE, comprising a processor; memory coupled with the processor; and instructions stored in the memory and executable by the processor to cause the apparatus to perform a method of any of aspects 1 through 8.

Aspect 32: An apparatus for wireless communication at a UE, comprising at least one means for performing a method of any of aspects 1 through 8.

Aspect 33: A non-transitory computer-readable medium storing code for wireless communication at a UE, the code comprising instructions executable by a processor to perform a method of any of aspects 1 through 8.

Aspect 34: An apparatus for wireless communication at a UE, comprising a processor; memory coupled with the processor; and instructions stored in the memory and executable by the processor to cause the apparatus to perform a method of any of aspects 9 through 17.

Aspect 35: An apparatus for wireless communication at a UE, comprising at least one means for performing a method of any of aspects 9 through 17.

Aspect 36: A non-transitory computer-readable medium storing code for wireless communication at a UE, the code comprising instructions executable by a processor to perform a method of any of aspects 9 through 17.

Aspect 37: An apparatus for wireless communication at a network entity, comprising a processor; memory coupled with the processor; and instructions stored in the memory and executable by the processor to cause the apparatus to perform a method of any of aspects 18 through 25.

Aspect 38: An apparatus for wireless communication at a network entity, comprising at least one means for performing a method of any of aspects 18 through 25.

Aspect 39: A non-transitory computer-readable medium storing code for wireless communication at a network entity, the code comprising instructions executable by a processor to perform a method of any of aspects 18 through 25.

Aspect 40: An apparatus for wireless communication at a network entity, comprising a processor; memory coupled with the processor; and instructions stored in the memory and executable by the processor to cause the apparatus to perform a method of any of aspects 26 through 30.

Aspect 41: An apparatus for wireless communication at a network entity, comprising at least one means for performing a method of any of aspects 26 through 30.

Aspect 42: A non-transitory computer-readable medium storing code for wireless communication at a network entity, the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving signaling indicating a configuration for the UE to communicate with a first transmission reception point and a second transmission reception point:
receiving a control signal identifying a set of channels sharing a common transmission configuration indication, the common transmission configuration indication comprising a first transmission configuration indicator state for the first transmission reception point and a second transmission configuration indicator state for the second transmission reception point; and
communicating with at least one of the first transmission reception point or the second transmission reception point according to the common transmission configuration indication based at least in part on the received control signal.

2. The method of claim 1, wherein receiving the control signal further comprises:
receiving the control signal identifying at least one channel associated with a second transmission configuration indication indicating one or more transmission configuration indicator states for the first transmission reception point, the second transmission reception point, or both, wherein the second transmission configuration indication is different from the common transmission configuration indication.

3. The method of claim 1, wherein receiving the control signal further comprises:
receiving the control signal identifying at least one reference signal type associated with a second transmission configuration indication indicating one or more transmission configuration indicator states for the first transmission reception point, the second transmission reception point, or both, wherein the second transmission configuration indication is different from the common transmission configuration indication.

4. The method of claim 1, wherein receiving the control signal further comprises:
receiving the control signal indicating that the set of channels associated with a common reference signal type shares the common transmission configuration indication.

5. The method of claim 1, further comprising:
receiving a downlink control information comprising a first transmission configuration indication field and a second transmission configuration indication field, wherein the first transmission configuration indication field indicates the first transmission configuration indication state, and the second transmission configuration indication field indicates the second transmission configuration indication state.

6. The method of claim 1, wherein the first transmission configuration indicator state, the second transmission configuration indicator state, or both comprise at least one of a respective joint transmission configuration indicator state, a downlink transmission configuration indicator state, an uplink transmission configuration indicator state, or any combination thereof.

7. The method of claim 1, wherein the set of channels comprises at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

8. The method of claim 1, wherein the control signal comprises a radio resource control signaling or medium access control (MAC) control element (MAC-CE) signaling indicating the set of channels.

9. A method for wireless communication at a user equipment (UE), comprising:
receiving signaling indicating a configuration for the UE to communicate with a first transmission reception point and a second transmission reception point:
receiving a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point; and
communicating with at least one of the first transmission reception point or the second transmission reception point according to the common transmission configuration indication based at least in part on the received control signal.

10. The method of claim 9, wherein receiving the control signal further comprises:
receiving the control signal identifying the mapping between the one or more channels and a transmission configuration indication field included in the common transmission configuration indication.

11. The method of claim 9, wherein receiving the control signal further comprises:
receiving the control signal identifying the mapping between a first transmission configuration indication codepoint and one or more transmission configuration indications associated with a physical downlink control channel and the mapping between a second transmission configuration indication codepoint and one or more transmission configuration indications associated with a physical downlink shared channel.

12. The method of claim 9, wherein receiving the control signal further comprises:
receiving the control signal identifying a transmission configuration indication codepoint of a single unified transmission configuration indication, wherein the single unified transmission configuration indication indicates one or more transmission configuration indication states for one or more channels configured without repetition.

13. The method of claim 9, wherein receiving the control signal further comprises:
receiving the control signal identifying a transmission configuration indication codepoint of a plurality of unified transmission configuration indications, wherein the plurality of unified transmission configuration indication indicates one or more transmission configuration indication states for one or more channels configured with repetition.

14. The method of claim 9, further comprising:
receiving a downlink control information message comprising a first transmission configuration indication field and a second transmission configuration indication field, the first transmission configuration indication field indicating one or more transmission configuration indication states for a physical downlink control channel, and the second transmission configuration indication field indicating one or more transmission configuration indication states for a physical downlink shared channel.

15. The method of claim 9, further comprising:
receiving a first medium access control (MAC) control element (MAC-CE) activating the first transmission configuration indicator state for the first transmission reception point, wherein communicating with the first transmission reception point is based at least in part on receiving the first MAC-CE; and
receiving a second MAC-CE activating the second transmission configuration indicator state for the second transmission reception point, wherein communicating with the second transmission reception point is based at least in part on receiving the second MAC-CE.

16. The method of claim 9, wherein the first transmission configuration indicator state, the second transmission configuration indicator state, or both comprise at least one of a respective joint transmission configuration indicator state, a downlink transmission configuration indicator state, an uplink transmission configuration indicator state, or any combination thereof.

17. The method of claim 9, wherein the control signal comprises a radio resource control signaling or medium access control (MAC) control element (MAC-CE) signaling indicating the one or more channels.

18. A method for wireless communication at a network entity, comprising:
outputting signaling indicating a configuration for a user equipment (UE) to communicate with a first transmission reception point and a second transmission reception point:
outputting a control signal identifying a set of channels sharing a common transmission configuration indication, the common transmission configuration indication indicating a first transmission configuration indicator state for the first transmission reception point and a second transmission configuration indicator state for the second transmission reception point; and
communicating with the UE according to the common transmission configuration indication based at least in part on outputting the control signal.

19. The method of claim 18, wherein outputting the control signal further comprises:
outputting the control signal identifying at least one channel associated with a second transmission configuration indication indicating one or more transmission configuration indicator states for the first transmission reception point, the second transmission reception point, or both, wherein the second transmission configuration indication is different from the common transmission configuration indication.

20. The method of claim 18, wherein outputting the control signal further comprises:
outputting the control signal identifying at least one reference signal type associated with a second transmission configuration indication indicating one or more transmission configuration indicator states for the first transmission reception point, the second transmission reception point, or both, wherein the second transmission configuration indication is different from the common transmission configuration indication.

21. The method of claim 18, wherein outputting the control signal further comprises:
outputting the control signal indicating that the set of channels associated with a common reference signal type shares the common transmission configuration indication.

22. The method of claim 18, further comprising:
outputting a downlink control information comprising a first transmission configuration indication field and a second transmission configuration indication field, wherein the first transmission configuration indication field indicates the first transmission configuration indication state, and the second transmission configuration indication field indicates the second transmission configuration indication state.

23. The method of claim 18, wherein the first transmission configuration indicator state, the second transmission configuration indicator state, or both comprise at least one of a respective joint transmission configuration indicator state, a downlink transmission configuration indicator state, an uplink transmission configuration indicator state, or any combination thereof.

24. The method of claim 18, wherein the set of channels comprises at least one of a dedicated reception on a physical downlink shared channel, a dedicated reception on a physical downlink control channel, a non-dedicated reception on the physical downlink shared channel, a non-dedicated reception on the physical downlink control channel, an aperiodic channel state information reference signal, a dynamic grant-based physical uplink shared channel, a configured grant-based physical uplink shared channel, dedicated physical uplink control channel, a sounding reference signal, or any combination thereof.

25. The method of claim 18, wherein the control signal comprises a radio resource control signaling or medium access control (MAC) control element (MAC-CE) signaling indicating the set of channels.

26. A method for wireless communication at a network entity, comprising:
outputting signaling indicating a configuration for a user equipment (UE) to communicate with a first transmission reception point and a second transmission reception point:
outputting a control signal identifying a mapping between one or more channels and one or more transmission configuration indication codepoints associated with a common transmission configuration indication, the common transmission configuration indication indicating a first transmission configuration indicator state for the first transmission reception point and a second transmission configuration indicator state for the second transmission reception point; and
communicating with the UE according to the common transmission configuration indication based at least in part on receiving the control signal.

27. The method of claim 26, wherein outputting the control signal further comprises:
outputting the control signal identifying the mapping between the one or more channels and a transmission configuration indication field included in the common transmission configuration indication.

28. The method of claim 26, wherein outputting the control signal further comprises:
outputting the control signal identifying the mapping between a first transmission configuration indication codepoint and one or more transmission configuration indications associated with a physical downlink control channel and the mapping between a second transmission configuration indication codepoint and one or more transmission configuration indications associated with a physical downlink shared channel.

29. The method of claim 26, wherein outputting the control signal further comprises:
outputting the control signal identifying a transmission configuration indication codepoint of a single unified transmission configuration indication, wherein the single unified transmission configuration indication indicates one or more transmission configuration indication states for one or more channels configured without repetition.

30. The method of claim 26, wherein outputting the control signal further comprises:
outputting the control signal identifying a transmission configuration indication codepoint of a plurality of unified transmission configuration indications, wherein the plurality of unified transmission configuration indication indicates one or more transmission configuration indication states for one or more channels configured with repetition.
